(19) United States
(12) Patent Application Publication
(10) Pub. No.: US 2013/0258967 A1
(43) Pub. Date: Oct. 3, 2013

(54) LOCAL INTERNET PROTOCOL ACCESS (LIPA) EXTENSIONS TO ENABLE LOCAL CONTENT SHARING

(71) Applicant: INTERDIGITAL PATENT HOLDINGS, INC., Wilmington, DE (US)

(72) Inventors: Mahmoud Watfa, Saint Leonard (CA); Kai Liu, S. Huntington, NY (US); Saad Ahmad, Montreal (CA)

(73) Assignee: INTERDIGITAL PATENT HOLDINGS, INC., Wilmington, DE (US)

(21) Appl. No.: 13/840,875

(22) Filed: Mar. 15, 2013

Related U.S. Application Data
(60) Provisional application No. 61/618,495, filed on Mar. 30, 2012.
(60) Provisional application No. 61/692,031, filed on Aug. 22, 2012.

(51) Int. Cl. H04W 76/02

(52) U.S. Cl. CPC H04W 76/02
USPC 370/329

(57) ABSTRACT

Methods and apparatus for enabling local content sharing are described. A wireless transmit/receive unit (WTRU) transmits a non-access stratum (NAS) message with a content sharing session request to a network entity. The network entity verifies that the WTRU and a sharing WTRU are allowed to participate in a content sharing session. Upon verification, the network entity sends a NAS response with the content sharing session set-up information to the WTRU and sends a resource allocation request for the content sharing session to other network entities. The WTRU establishes the content sharing session between the WTRU and sharing WTRU using a local gateway (LGW) connection absent non-local entity connections and transmits content between the WTRU and the other WTRU using the LGW connection during the content sharing session.

### CROSS REFERENCE TO RELATED APPLICATIONS

This application claims the benefit of U.S. Provisional Application No. 61/618,495, having a filing date of Mar. 30, 2012, and U.S. provisional application No. 61/692,031, having a filing date of Aug. 22, 2012, the contents of which are hereby incorporated by reference herein.

### BACKGROUND

Local internet protocol (IP) access (LIPA) and Selected IP Traffic Offload (SIPTO) are techniques that permit usage of local network or as near edge network resources as opposed to core network resources. Local internet protocol (IP) access (LIPA) allows a wireless transmit/receive unit (WTRU) to establish a packet data network (PDN) connection to a local gateway (LGW), which may have the functionality of a PDN GW, in order to establish an IP connection with a local IP network. Selected IP Traffic Offload (SIPTO) allows an operator to select a PDN GW that takes into account the location of the WTRU. This may help offload the other PDN GWs in the core network from handling all the traffic for all WTRUs. As such, a WTRU's PDN connection may be torn down and re-established if the network realizes it is advantageous to do so based on the WTRU location.

### SUMMARY

Methods and apparatus for enabling local content sharing are described. A wireless transmit/receive unit (WTRU) transmits a non-access stratum (NAS) message with a content sharing session request to a network entity. The network entity verifies that the WTRU and a sharing WTRU are allowed to participate in a content sharing session. Upon verification, the network entity sends a NAS response with the content sharing session set-up information to the WTRU and sends a resource allocation request for the content sharing session to other network entities. The WTRU establishes the content sharing session between the WTRU and sharing WTRU using a local gateway (LGW) connection absent non-local entity connections and transmits content between the WTRU and the other WTRU using the LGW connection during the content sharing session.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a diagram illustrating the development of the Local Internet Protocol Access (LIPA);

FIG. 3 is a diagram illustrating a local network (LN) that may be defined as the coverage area defined by several home Node-Bs (HNBs) that may connect to one or more local gateways (LGWs), and also data sharing in the LN;

FIG. 4 is a diagram of an implementation of LIPA where two wireless transmit/receive units (WTRUs) under the same LN that may share data via an LGW;

FIG. 5 is a diagram of an implementation of LIPA where a WTRU may obtain data from the packet data network (PDN) GW and share it with another WTRU in the LN;

FIG. 6 is a diagram of an implementation of LIPA where a plurality of WTRUs are in different LNs and would like to share data;

FIG. 7 is a diagram of an implementation of LIPA extending the implementation of FIG. 6 to a WTRU that is not in a local network but would like to share its content with another WTRU in the LN.

FIG. 8 is a diagram of an implementation of LIPA where a WTRU is under the coverage of a local home network (LHN) and would like to share its content with another WTRU that is under macro coverage and does not have closed subscriber group (CSG) membership to the LHN;

FIG. 9 is a diagram of an implementation of LIPA showing how the embodiments of FIGS. 4-8 may be used;

FIG. 10 is a flow diagram of the example implementation of FIG. 9; and

FIG. 11 is a diagram of an example signaling flow for embodiments such as the embodiments of FIGS. 5-7 or any embodiment in which on WTRU attempts to share data that is being downloaded from an IP network for a PDN GW or an LGW.

### DETAILED DESCRIPTION

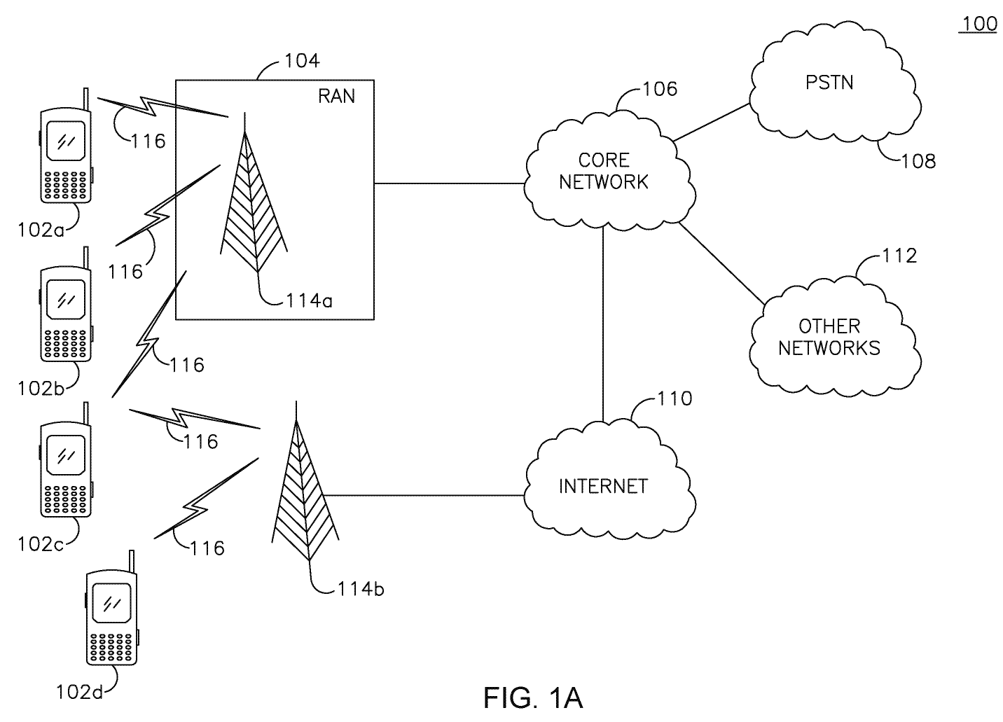

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Additionally, while the transceiver 120 is shown as a single element, it may be implemented as separate transmitter and receiver units.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

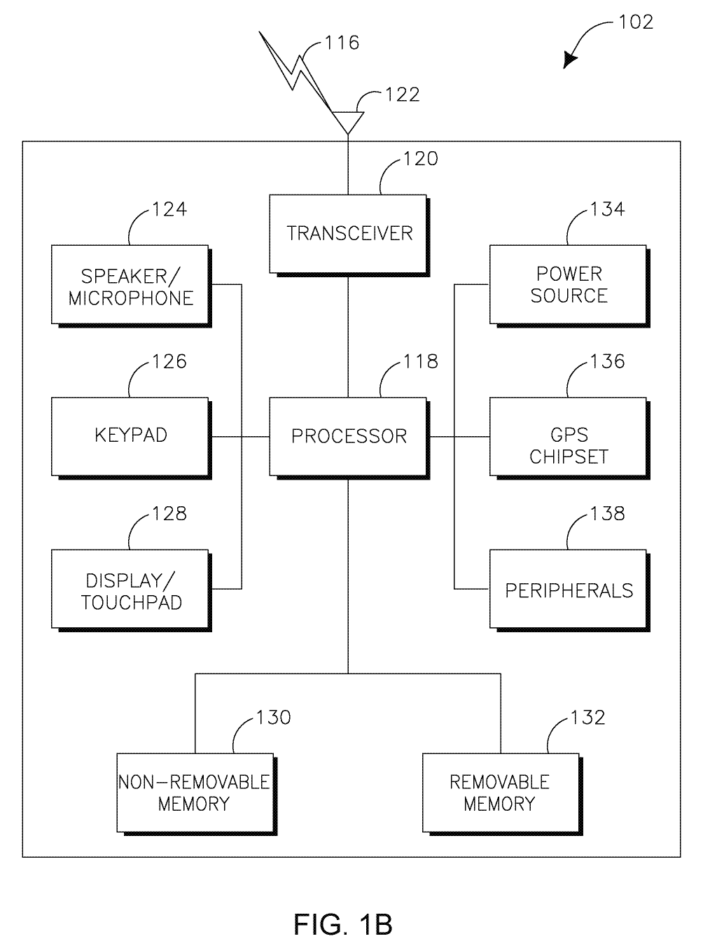

FIG. 2 is a diagram 200 illustrating the development of the Local Internet Protocol Access (LIPA) work from 3^{rd} Generation Partnership Project (3GPP) Release 10 201, Release 11 202 and future releases 203. In Release 10 201, a local gateway (LGW) 205 is physically collocated with a home Node-B (HNB) 210 or home eNode-B (HeNB), which is also connected to a core network (CN) 212. The LGW 205 provides access to a local IP network 207. A WTRU 215 may establish a packet data network (PDN) connection with the LGW 205, (a LIPA PDN connection), and may have an Internet Protocol (IP) session with the local IP network 207, (a LIPA session). There is no LIPA session continuity in Release 10 when the WTRU 215 leaves the HNB 210. The LIPA session is terminated when the WTRU 215 is not under the coverage of the HNB 210, (e.g., due to handover or idle mode reselection). In Release 11 202, a LGW 230 is standalone and provides access to a local IP network 231. Multiple HNBs 232 and 233 may connect to the LGW 230 and may also be connected to CN 234. A WTRU 235 may establish a PDN connection in one HNB 232 and may have an IP session with the local IP network 231, (a LIPA session). The LIPA session may be continuous as the WTRU 235 moves from one HNB 232 to another HNB 233, assuming, for example, that the target HNB connects to the LGW 230, (among other requirements). When the WTRU 235 leaves the coverage area of all the HNBs 232 and 233 that connect to the LGW 230, the LIPA PDN connection is deactivated.

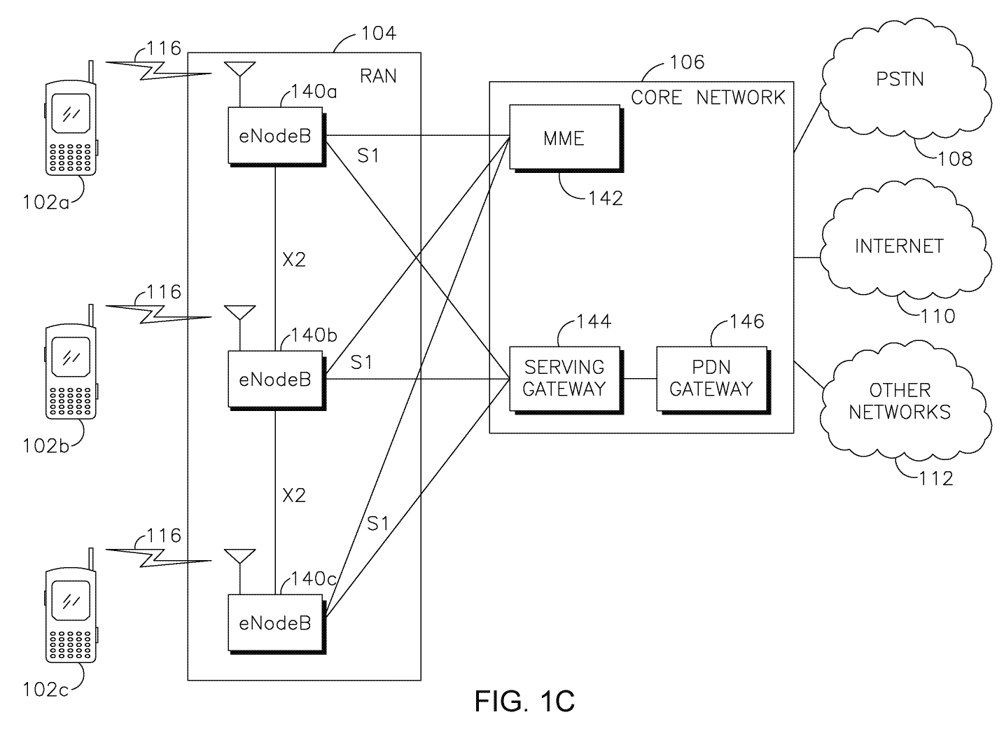

FIG. 3 is a diagram 300 illustrating the development of LIPA from Release 10 301, Release 11 302 and in particular, future releases 303. In future releases 303, a LGW 305 provides access to a local IP network 320. Multiple HNBs 325 and 330 may connect to the LGW 305 and may also be connected to CN 335. A local network (LN) 340 may be defined as the coverage area defined by several HNBs, for example, HNBs 325 and 330, which may connect to one or more LGWs, for example, LGW 305. A WTRU 345 may establish a PDN connection in one HNB 325 and may have an IP session with local IP network 310, (a LIPA session). A WTRU 350 may also have a LIPA session with local IP network 310 either via HNB 325 or HNB 330. In this instance, the WTRUs 345 and 350 may decide to share content since they are both within the same LN 340.

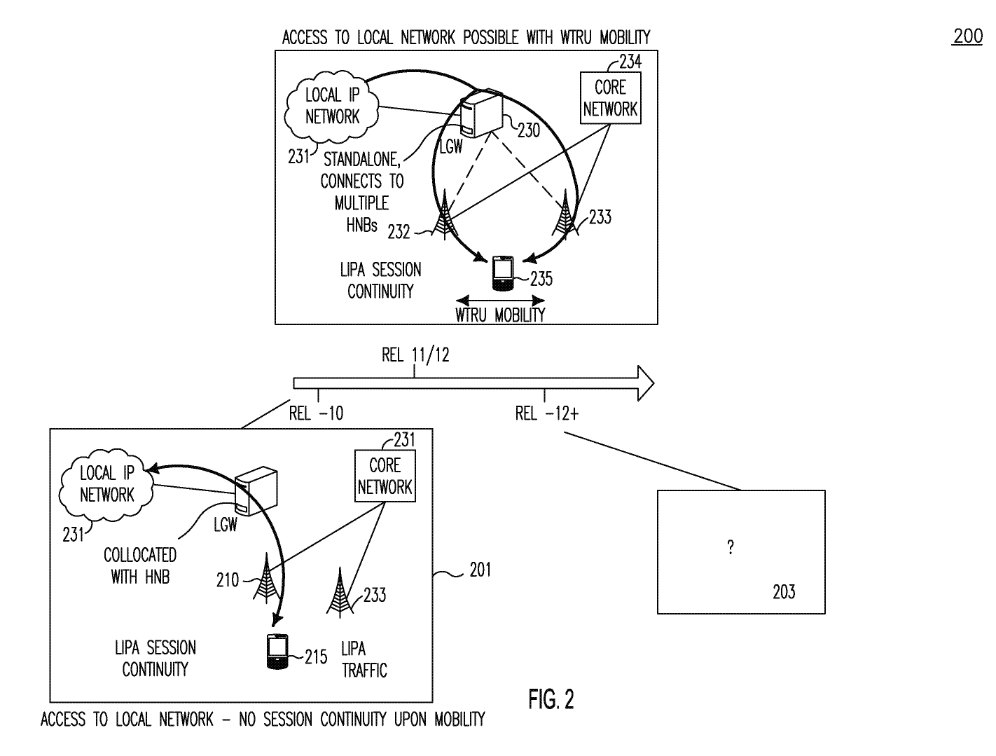

An example implementation/deployment of an LGW may be, for example, in a campus scenario where multiple HNBs may connect to an LGW. In this scenario, there may be implementations in which WTRUs may be camping on different HNBs, but which may connect to the same LGW. In particular, the WTRUs may decide to share content since they are both within the same LN. In such an implementation, the content to be shared may be from the local network, and this may be fetched by one WTRU and then shared with another. For example, the content may be fetched from another PDN GW, (for example that in the CN), and then shared with another WTRU via an LGW. Embodiments described herein may enable local content sharing, for example, as described with respect to FIGS. 4-8.

While the implementations described with respect to FIGS. 4-8 below are illustrated and described with respect to LIPA, they may also be applicable to Selected IP Traffic Offload (SIPTO) at the local network (SIPTO@LN). Thus, the term LIPA may refer to LIPA or SIPTO@LN, and all of the embodiments described herein may be applicable to one or both of LIPA and SIPTO@LN. Further, any data to be shared may be data that is already available in a WTRU or may be data that is actively being downloaded in a WTRU either via 3GPP methods or using other non-3GPP methods. For example, a WTRU may have an active Internet Protocol (IP) session via a PDN connection that is obtained with a 3GPP network and may later choose to share some or all of the data. In another example, the data to be shared may be first downloaded (or cached) in the WTRU or may be shared as it is being downloaded to the WTRU. In addition, the procedures described herein may apply to long term evolution (LTE) and/or third generation (3G)/second generation (2G), (or any other radio access technology (RAT)), systems even though the embodiments described herein may be described from an LTE perspective. Further, the term HNB may be used herein to refer to closed subscriber group (CSG) (or HNB) in 3G and LTE systems as well. For all of the architectural solutions of FIGS. 4-8, the LGW may be standalone or may be collocated with an HNB.

FIG. 4 is a diagram of a LIPA implementation 400 which includes a LGW 405 that provides access to a local IP network 410. A pair of HNBs 415 and 420 may be connected to the LGW 405 and to a CN 425. A local network (LN) 427 may be defined as the coverage area defined by HNBs 415 and 420. A pair of WTRUs 430 and 435 may establish PDN connections with the applicable HNBs 415 and 420 and may have IP sessions with local IP network 410 via the LGW 405. In this scenario, the WTRUs 430 and 435 are under the same LN 427 and may want to share data via the LGW 405. In general, the data to be shared may be obtained from the local IP network 410, or may be obtained, for example, via a PDN GW CN, or may have been obtained by other methods such that the data already resides in the WTRUs. For example, WTRU 430 may obtain the data from local IP network 410 (1) and share the obtained data with WTRU 435 via the LGW 405 (2).

The architectural solution of FIG. 4 may enable data sharing in cases where both WTRUs are under the same LGW. It may also be possible for both WTRUs to be under the same HNB, (not illustrated). Further, the data to be shared may be first fetched from an LGW connection and then shared. Even further, the data may also be shared as it is being actively downloaded from the LGW, (not illustrated, and the data may be fetched from an LGW connection and shared at same time).

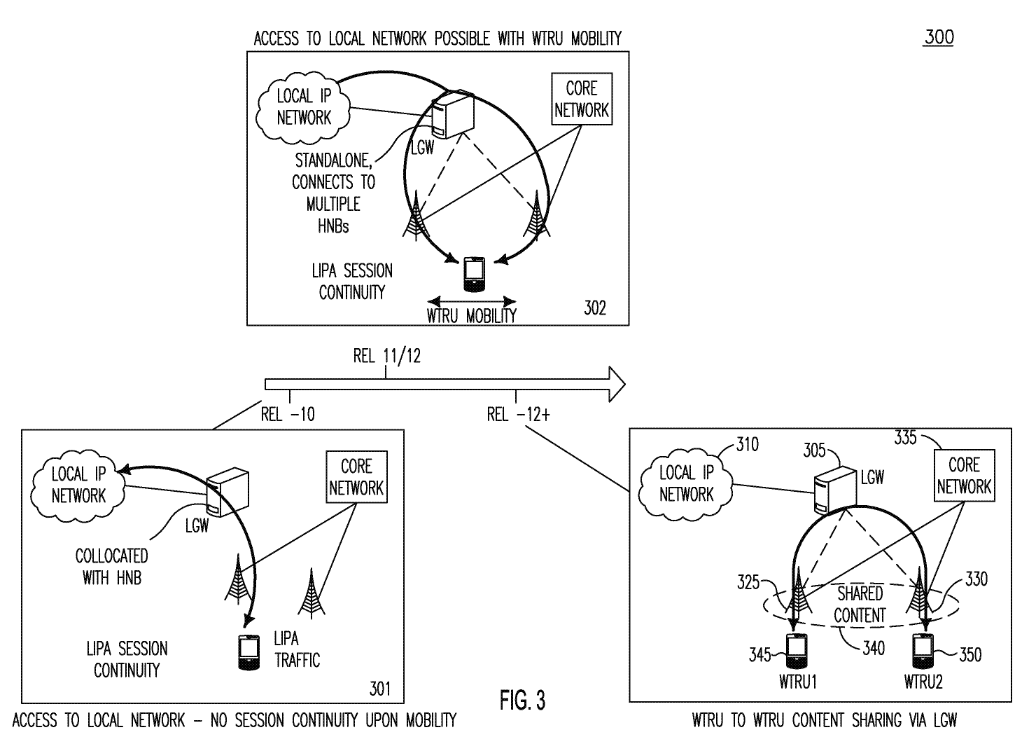

FIG. 5 is a diagram of a LIPA implementation 500 which includes a LGW 505 that provides access to a local IP network 510. A pair of HNBs 515 and 520 may be connected to the LGW 505 and to a CN 525, which in turn may include a PDN GW 527 that provides access to the Internet 528. A LN 526 may be defined as the coverage area defined by HNBs 515 and 520. A pair of WTRUs 530 and 535 may establish PDN connections with the applicable HNBs 515 and 520 and may have IP sessions with local IP network 510 via the LGW 505. In this scenario, the WTRUs 530 and 535 are under the same LN 526 and may want to share data via the LGW 505. In this implementation, the WTRU 530 may obtain data from the PDN GW 527 and share it with WTRU 535. The sharing (2) may be performed as the data is being downloaded to WTRU 530 via the IP connection (1) with the PDN GW 527. In another embodiment, the data may first be obtained by the WTRU 530, which may then be shared with WTRU 535. The architectural solution of FIG. 5 is similar to the architectural solution in FIG. 4 except that the data to be shared may be obtained using a PDN connection from the CN and everything described herein above with respect to the architectural solution of FIG. 4 may also be applicable for the architectural solution of FIG. 5.

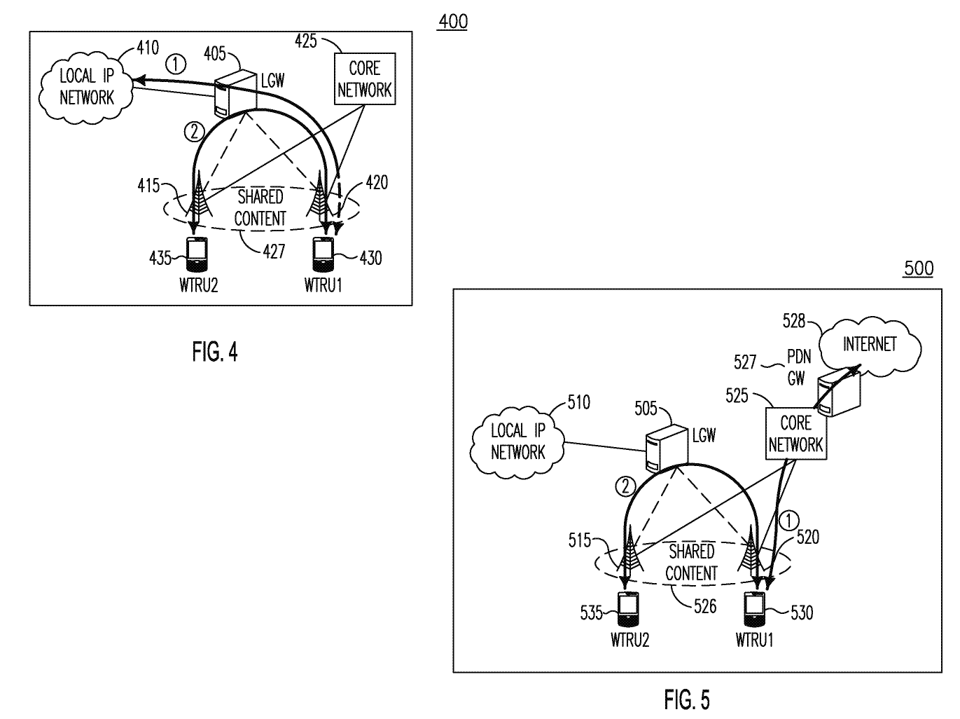

FIG. 6 is a diagram of a LIPA implementation 600 where a plurality of WTRUs are in different LNs and would like to share data. LIPA implementation 600 includes LGW1 605 and LGW2 607, which may be connected via a tunnel 608 and which provide access to local IP network X 610 and local IP network Y 612. A first set of HNBs 615 and 617 may be connected to LGW1 605 and second set of HNBs 619 and 621 may be connected to LGW2 607. A LN1 625 may be defined as the coverage area defined by HNBs 615 and 617 and a LN2 627 may be defined as the coverage area defined by HNBs 619 and 621. A WTRU 630 may establish a PDN connection with the applicable HNBs 619 and 621 and may have an IP session with applicable local IP network X 610 and local IP network y 612 via LGW 607. A WTRU 635 may establish a PDN connection with the applicable HNBs 615 and 617 and may have an IP session with applicable local IP network y 610 and local IP network y 612 via LGW 605. A shown, each WTRU may have a LIPA PDN connection with a different LGW, and the LGW may connect to more than one IP data network. The architectural solution of FIG. 6 is similar to the architectural solution of FIGS. 4 and 5 except that, here, both WTRUs may belong to different LGWs.

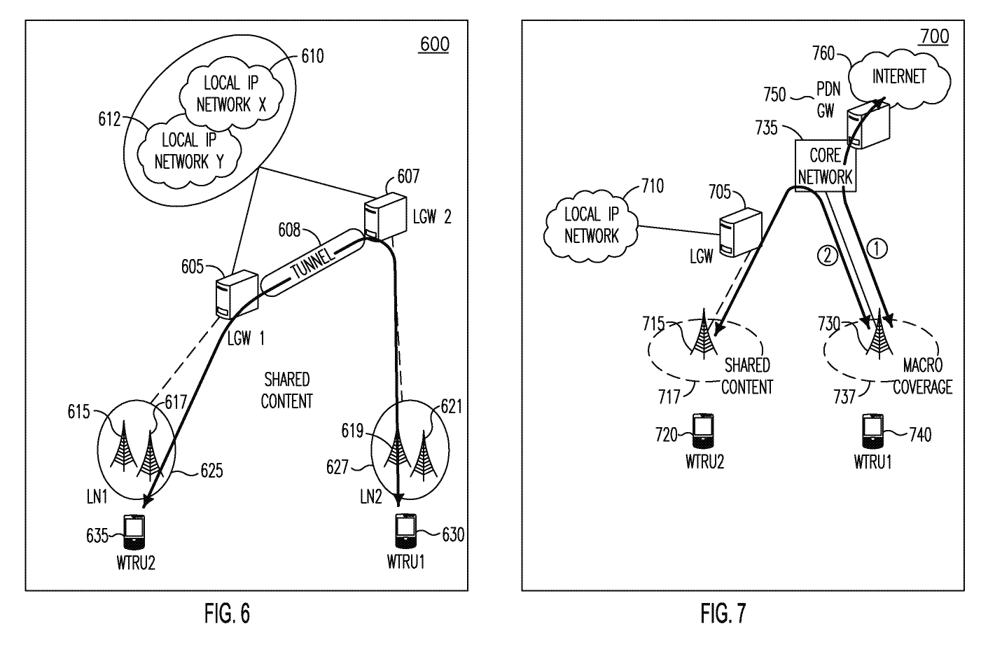

FIG. 7 is a diagram of a LIPA implementation 700 which extends the LIPA implementation 600 of FIG. 6 to a WTRU that is not in a local network but would like to share its content with another WTRU in the LN. LIPA implementation 700 includes a LGW 705 which provide access to local IP network 710. A HNB 715 may be connected to LGW 705. A LN 717 may be defined as the coverage area defined by HNB 715. A WTRU2 720 may establish a PDN connection with HNB 715 and may have an IP session with local IP network 710 via LGW 705. A base station 730 may be connected to a CN 735 and have a macro coverage cell 737 defined by the base station 730. A WTRU 740 may be in macro coverage cell 737 and may decide to share data with WTRU 720 in LN 715. For example, WTRU 740 may obtain the data from a PDN GW 750 (1), which is connected to an Internet 760. The obtained data may be shared with WTRU 720 via LGW 705 connection. The assumptions that are applicable to the architectural solutions associated with the implementations described with respect to FIGS. 4-6 may also be applicable here except that one of the WTRUs may be in macro coverage and may want to share data with another WTRU in a local network, (optionally under an LGW).

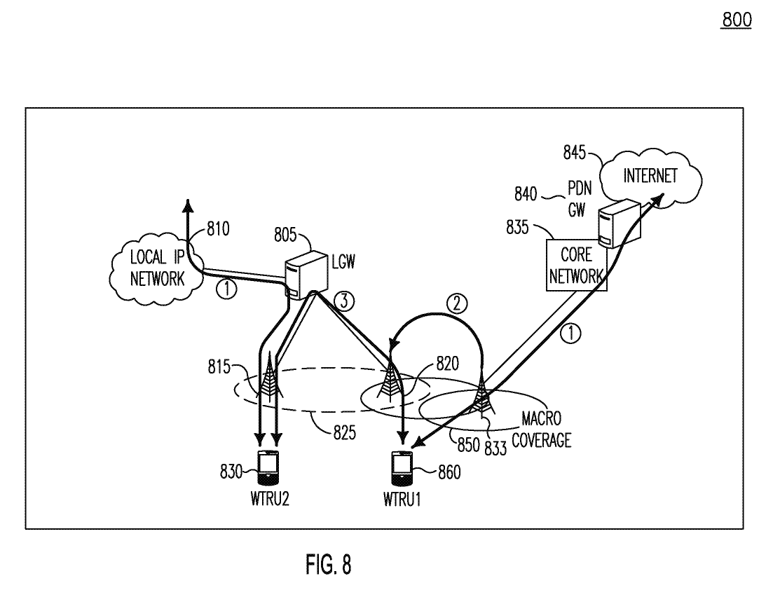

FIG. 8 is a diagram of a LIPA implementation 800 where a WTRU is under the coverage of a local home network (LHN) and would like to share its content with another WTRU that is under macro coverage and does not have closed subscriber group (CSG) membership to the LHN. LIPA implementation 800 includes a LGW 805 that provides access to a local IP network 810. A pair of HNBs 815 and 820 may be connected to the LGW 805. A local home network (LHN) 825 may be defined as the coverage area defined by HNBs 815 and 820. A WTRU 830 may establish a PDN connection with LGW 805 and may have an IP session with local IP network 810 via the LGW 805 (1). A base station 833 may be connected to a CN 835, which in turn may include a PDN GW 840 connected to Internet 845. The base station 833 may have a macro coverage cell 850. The macro coverage cell 850 may have overlap with a coverage cell of HNB 820. A WTRU 860 may be in the macro coverage cell 850. In this implementation, there may be a tunnel from WTRU's 830's LHN 825 to WTRU's 860 operator network.

To enable content sharing in LIPA implementation 800, WTRU 860 may request a CSG, (or it may request a CN via a MME), to grant a temporary CSG membership to WTRU 860 with limited privileges, (for implementing data radio bearers (DRB) for content sharing purposes). WTRU 830 may send a content sharing invitation to WTRU 860 including information about the granted temporary CSG membership. WTRU 860 may perform a manual CSG search to camp on a cell that belongs to the CSG, or example, HNB 820. Alternatively, WTRU 860 may request a network for CSG reading. Once WTRU 860 identifies a CSG cell, it may detach from its current operator and reattach via the CSG cell for be handed over to the CSG cell. After WTRU 80 is under the coverage of the CSG, WTRU 830 may establish the DRB for content sharing between WTRU 830 and WTRU 860.

In the embodiments described herein, an initiating WTRU (iWTRU) may initiate a data sharing session with another WTRU or group of WTRUs, and a receiving WTRU (rWTRU) may receive shared data from an iWTRU. In an embodiment, one or many rWTRUs may receive shared data from an iWTRU simultaneously. In an embodiment, every WTRU may be an iWTRU and an rWTRU simultaneously, (a WTRU may have multiple shared data sessions with multiple other WTRUs and, thus, such a WTRU may be an iWTRU for one session and an rWTRU for another session).

Permission for the WTRU to share data in local networks, (or in general), may be added to a WTRU's or a user's subscription profile and may be provided to the CN nodes such as the MME and the serving general packet radio service (GPRS) support node (SGSN). Further, the following granularities may be defined and may be used in any combination. For example, whether or not sharing is allowed on a specific LN, (e.g., whether or not the different WTRUs may be in different LNs or the WTRUs need to be in the same LN for sharing), may be defined. In another example, whether or not sharing is allowed on a specific LGW/access point name (APN) and/or whether or not sharing is allowed across different LGWs/APNs, (note that a data session may not be allowed if the WTRUs under consideration do not have a LIPA PDN connection or a PDN connection for SIPTO@LN). In another example, whether or not sharing is allowed for a specific APN and/or whether or not the APN refers to an APN for a LIPA connection, an APN for a CN PDN connection, or an APN for SIPTO@LN may be defined. In another example, a maximum bit rate that may be shared, a type of data that may be shared or a type of quality of services that may be shared may be defined.

In another example, whether or not the WTRUs with which the data may be shared must be confined to the same LN, CSG cell, or LGW and/or whether or not the WTRUs with which data may be any WTRU or may be part of a “friend” list WTRU may be defined. Thus, a “friend” list WTRU may be defined that may define a set of WTRUs that may share data at a flat charging rate. Further, if a WTRU wants to share data with another WTRU that is not part of this “friend” list, then additional charges may apply. In another example, whether or not sharing is allowed on a per public land mobile network (PLMN) basis and/or whether visited PLMNs may be allowed, (e.g. when a WTRU is roaming), may be defined. In another example, whether or not the data to be shared should be obtained via 3GPP system (procedures) or the data may be obtained from another non-3GPP RAT may be defined. In another example, whether or not the data to be shared should be local data, (e.g., obtained from an LN), or whether the data to be shared may be obtained from any other source, (e.g. via the PDN GW in the CN), may be defined.

In another example, whether or not data to be shared should first be local to a WTRU or whether it may be shared as it is being downloaded to a WTRU may be defined. In the latter case, resources may need to be set up such that any data from an IP endpoint will be transferred such that it is received at the WTRU that initiated the IP session and also at the WTRU with which data is desired to be shared by the first WTRU. In another example, it may be defined that a WTRU may have permission to share data with another WTRU, to only receive data from another WTRU, or both. Further, a WTRU may be allowed to share data with only one WTRU at a time. In another example, whether or not data to be shared needs a license agreement and whether specific WTRUs have a license agreement to share or receive data, (optionally from other WTRUs), may be defined. The network, (MME, SGW, PGW/LGW, HNB, HNB GW or any other node), may contact a designated entity, (e.g., copyright management application server), either directly or via an Interworking Function (IWF) Node to verify that content to be shared is allowed. This may be done at the establishment of the session or at the time of initiation of the sharing, which may occur during handover.

In another example, it may be defined that the system should allow the WTRUs to exchange information, (e.g., via Short Message Service (SMS) or other means), before a session sharing may be initiated. In another example, whether or not sharing is allowed on a per flow basis and whether flows may be sent over multiple paths may be defined. By way of example, a specific type of traffic may require different treatment in terms of data path and may be subject to a different charging rate. Thus, one type of traffic flow may be allowed to go via one LGW but not across two LGWs, while another type of traffic flow may be allowed to traverse across different LGWs.

The above examples may be used in any combination. Also, these conditions may reside and be verified by any node, (e.g., RAN nodes, CN nodes (such as MME/SGSN/LGW/HNB GW, and the like) and the like).

Described herein are other enablers for content sharing. An identification may be defined that may be used to identify one or more WTRUs with which data should be shared. The identification may be per WTRU or for a group of WTRUs. Possible identification parameters may include an IP address, a uniform resource identifier (URI) or email-like address, other unique identification that may be set by the user and controlled by the operator, and a GSM mobile subscriber integrated services data network (MSISDN), (e.g. if the WTRU supports circuit switched (CS) voice calls, it may already have an MSISDN assigned). A set of devices may form a group that may be identified with one identity, (as proposed herein whenever possible), and other WTRUs may share data with the group based on this identity. Thus, for data sharing, the WTRUs that are involved in sharing should use one of these methods to identify the other WTRU, (or group of WTRUs), and signal the identity to the network.

A WTRU may be notified as to which data is to be shared. For example, a WTRU may be notified that there is data to be shared with it. A user may be provided with an option to accept or reject the data sharing or with an option to terminate data sharing at any time. In another example, a WTRU may be notified about the identity of the WTRU that is attempting to share data with it. In another example, a WTRU may be notified about the type of data that is to be shared. Thus, a WTRU may need to identify the type of data that it desires to share with another WTRU. This may be signaled with the network and eventually to the WTRU with which data is to be shared. In another example, a WTRU may be notified about what contents are available for sharing from other WTRUs that are allowed to share data with it. The WTRU may selectively access the available sharable resources/data. The system may allow one WTRU to acquire such information from all WTRUs that may share data with it. The system may also allow a WTRU to query such information from individual WTRUs.

Resources for sharing data may be cleared up when any of the following occurs: when an rWTRU or an iWTRU decides to terminate a shared data session; when a specific time, (e.g., configurable time at the WTRU or the network), elapses without having data exchange; when one of the WTRUs moves into a location where data sharing is not allowed, (or leaves a location where data sharing is allowed), or is not possible; and/or upon expiry of a CSG subscription or removal of a WTRU from a “sharing group,” which may be defined by the network as a group of WTRUs that may share data in, for example, an LN. The group may be made aware to all the involved WTRUs via non-access stratum/radio resource control (NAS/RRC) messages or via Open Mobile Alliance (OMA) Device Management (DM), over-the-air (OTA), SMS, and the like.

In an embodiment, a WTRU may suspend, (and hence later resume), a shared data session. When this happens, both WTRUs may be notified about the suspension. It may also be possible to set a time during which data sharing is initiated automatically by a WTRU or to set a time window during which data sharing is allowed, (and hence not allowed outside of this time window). The time window during which data sharing may be allowed may be signaled to the WTRU, may be configured in the WTRU or may be provided via OMA DM or OTA methods.

In an embodiment, a list may be stored in the network and in the WTRU. The list, for example, may include a list of users/WTRUs with which data sharing is allowed. This list may be modified via OMA DM or OTA or via specific indications in NAS signaling. For example, a WTRU may add a user to this list if the user accepts a data sharing session and the user is not already in this list. Alternatively, the WTRU may be informed to add or remove an entry via OMA DM. Also, a WTRU may remove an entry from this list if the WTRU relating to that entry rejects a data sharing session. In another example, the list may include a list of users/WTRUs that may include the WTRUs that are not allowed to initiate a session with the WTRU under consideration. By way of example, any WTRU may include such a list, and all the entries may identify the WTRUs that are not allowed to initiate a session with the WTRU. The WTRU may update the network with such information via NAS signaling, OMA DM or OTA. The user may also add an entry via the user interface. In another example, the list may include a list of users/WTRUs with which the WTRU under consideration is not allowed to initiate a data sharing session. By way of example, any WTRU may contain such a list and all the entries may identify the WTRU with which the WTRU is not allowed to initiate a data session. This list may be modified via OMA DM, OTA or via specific indications in NAS signaling. For example, a WTRU may add a user to this list if the user initiates a data session towards this WTRU. Alternatively, the WTRU may be informed to add or remove an entry via OMA DM. Also, a WTRU may add an entry to this list if the WTRU relating to that entry rejects a data sharing session.

In an embodiment, a unique identity may be assigned to every data sharing session that may be in place between WTRUs. The identity may be assigned by the WTRU, (e.g., iWTRU or rWTRU), the MME, the LGW, and the like. This identity may be forwarded to all the nodes that are involved. For example, if the MME assigns the identity, then the MME may forward this identification to the WTRUs in question, the SGW, the LGW, (e.g. via the SGW), and the RAN nodes. These nodes may later use this identity to uniquely refer to a given session in any signaling or procedure that may be executed.

The following triggers, (which may be used in any combination), may be defined as possible ways to initiate a data sharing session. For example, a data sharing session may be initiated upon activation of a certain type of PDN connection. For another example, when a WTRU activates a PDN connection for LIPA (or SIPTO@LN), then, given that the WTRU has an active LIPA connection, the WTRU may be able to share data in the LN with other WTRUs. For another example, the MME may, upon activation of a PDN connection for LIPA (or SIPTO@LN), verify if such a WTRU is allowed data sharing services in a specific LN, (or for the PDN connection just established, optionally based on the APN provided). The MME may then verify what other WTRUs are also connected to the same LGW, LN, or APN. The MME may update every WTRU that also has a PDN connection of the same characteristics, (e.g., being LIPA/SIPTO@LN, same APN, being under the same LN, and the like), about the presence of a new WTRU. The MME may also update the new WTRU about existing WTRUs that already have a similar connection. Any WTRU may be provided with such information using NAS or RRC messages, or other messaging, such as OMA DM, OTA, SMS, and the like.

The above may be executed by the LGW, (or any other RAN node). For example, the LGW may have information about which WTRUs are allowed to have data sharing. Thus, for every PDN connection activation/deactivation and/or bearer activation/deactivation/modification, the LGW may trigger the communication of presence information to the WTRUs that are connected to it. This may be done via the MME or via a direct interface with the HNBs, which may then forward the information to the WTRU via RRC messages. The example of informing WTRUs about a presence of others may also be applicable to the case where a WTRU connects to a CSG. For example, after a handover (HO) to a CSG or due to manual CSG selection, the network may know that the WTRU is in a particular CSG cell and may inform other WTRUs about the presence of this WTRU in the LN. Further, the presence lifetime may be tied to the CSG subscription lifetime. Hence, CSG subscription expiry at the network may also trigger update of presence information to other WTRUs.

In another example, a data sharing session may be initiated upon reception, by a WTRU, of a dedicated request by the network to initiate a data sharing session, optionally with a specific WTRU. In another example, a data sharing session may be initiated upon handover to a cell that supports data sharing. For example, a WTRU may be handed over to an HNB and may be informed via RRC messages, (such as an RRC HO command), that data sharing in the LN is available.

The following triggers, (which may be used in any combination), may be defined as possible ways to terminate/modify/suspend a data sharing session: the iWTRU deregisters from the network; the iWTRU sends an explicit request to the network, (e.g. NAS or RRC message), to terminate data sharing with specific WTRUs; a WTRU receives an explicit request to terminate a sharing session, (may be with a specific WTRU); expiry of a timer that may have been defined as a time period during which data sharing is allowed; expiry of CSG subscription; and deactivation of a LIPA PDN connection or deactivation of a bearer that was used for LIPA or SIPTO@LN.

Described herein are methods to enable the implementations described herein above with respect to FIGS. 4-8. As a precursor, the WTRUs may need to discover each other. For example, the MME may inform all WTRUs that have a LIPA connection with the same LGW that other WTRUs have joined the LGW.

Described herein are methods to enable the implementations described herein above with respect to FIG. 4. Both the iWTRU and the rWTRU may be in the same LN. Specifically, both WTRUs may be under the same LGW and may be under the same or different HNBs (or HeNBs). The methods described below may also be applicable to the case in which there is a collocated LGW on an HNB with both the iWTRU and the rWTRU under the same HNB.

The actions that may be taken by the WTRU, (e.g., iWTRU and rWTRU), CN, and RAN nodes for setting resources to enable data sharing are described. The procedure may either be successful or unsuccessful, (both cases are addressed).

In order to start a data sharing session, the following may be performed by an iWTRU. The iWTRU may send a new NAS message to the CN node, (e.g., MME or SGSN), to request a session for data sharing. The request may also be an existing NAS message with additional information elements (IEs). The NAS message (new or existing) may include one of the following: a request type with a value defined to indicate a session for data sharing; the type of data to be shared, (e.g., local data in the WTRU, data that is to be downloaded from a LGW (LIPA or SIPTO@LN), data that is to be downloaded from the PDN GW in CN, etc.)); the identity of the rWTRU with which the data is to be shared, (the identity may be any of the possible identities identified earlier); the identity of the iWTRU, (may be different from NAS-specific identities such as System Architecture Evolution (SAE)-Temporary Mobile Subscriber Identity (S-TMSI) and, thus, the iWTRU may include one of the identities proposed earlier); and the type/description of data to be shared. This latter may be configured in the WTRU or may be based on a user input via a display interface. The type of data may be the quality class, data rate, whether the data is local, or is obtained via a PDN GW in the CN. Further, the WTRU may indicate whether the data to be shared should be shared concurrently to both WTRUs as it is being downloaded or the data should first be downloaded to the iWTRU before sharing with the rWTRU. Such decisions may also be based on network policies.

The iWTRU may also include an indication to notify the network that the user/iWTRU accepts additional charges for such a session. Further, the iWTRU may include a code, (or other information), that allows the network to charge the iWTRU for data sharing instead of charging the rWTRU. The iWTRU may also include the name of the LN in which data is to be shared. There may be an LN name for the iWTRU and an LN name for the rWTRU. The iWTRU may also include an HNB name in the request where the HNB name may be that of the iWTRU and/or the rWTRU. The iWTRU may also include a displayable message intended for at least one rWTRU. Thus, the network may forward such information to the target WTRU, which may display the message to the user. The user/rWTRU may accept or decline the request, (e.g., based on this message (e.g., the message may help the user make a decision to accept or decline the request)).

The request to initiate data sharing may also be done via an RRC message to the HNB (or serving cell). The WTRU may include all the information described above in a new or existing RRC message. Upon reception, the HNB may in turn “consult” with the CN on whether this service may be granted. The HNB may forward any new information received from the WTRU in the S1AP message, (which may be new or existing). The MME may process this information as described herein below that explains MME behavior when a similar NAS message is received. The MME, for example, may accept the request and inform the necessary nodes (as described below) to set up resources for data sharing. The HNB may receive an accept response from the MME, and the HNB may in turn respond to the RRC request that was received from the WTRU.

If the session is accepted, the WTRU may receive a new NAS message indicating the acceptance of the data sharing session. This indication may also be achieved by using an existing NAS message with additional or modified IEs. The message may include at least one of the following. The message may include the result of the session initiation request. In this case, the result may indicate the acceptance of the request for data sharing. The WTRU, (e.g., the NAS layer), may indicate the result to the upper layers, (e.g., the application layer). The message may include the identity of the rWTRU with which sharing may be done. The message may include a timer during which sharing is permitted or a timer during which the session may be expected to be active and, after which, the session terminates and the WTRU may need to setup another sharing request if needed. The message may include charging indications that, for example, may indicate additional charges that are applicable to this session. The WTRU may thus display such indications to the user which can then use this to continue or terminate the session.

The WTRU may also be informed to setup a specific bearer or PDN connection. The WTRU may then initiate the requested procedure. The WTRU may autonomously, or based on an indication, add the rWTRU's identity to the list of allowed WTRUs (described above). The WTRU may receive an IP address of at least one rWTRU such that data sharing may be possible. The WTRU may use this IP address for direct data sharing with at least one rWTRU. The WTRU/NAS may provide this IP address and any other identification or necessary information to upper layers. The WTRU may receive an indication that a specific evolved packet system (EPS) bearer, (or data radio bearer), is to be used for data sharing. This indication may be included in the RRC messages, (e.g., RRC Connection Reconfiguration message), or in NAS messages such as those used to activate or modify dedicated bearers.

The WTRU may set up a PDN connection in response to the acceptance of the data session sharing. Alternatively, a PDN Connection Request message may actually be used to indicate that a data sharing session is requested. The following modifications may be done to the PDN Connection Request message. A new PDN request type may be defined such that it indicates that the connection is for peer-to-peer sharing, (and may be within a local network). Thus, there may be a new request type for sharing within a local network or for sharing out of a local network. The APN field may be modified to include the identity of the rWTRU or the iWTRU. The identity of the rWTRU and/or that of the iWTRU may be included in this message, (as other IEs). Also, a list of WTRUs that may be contacted may also be included, possibly identified with a group ID. A common CSG ID/LN or HNB name may also be used for this purpose and may be interpreted as a request to share data with all the WTRUs that may be connected to that CSG, HNB or LN.

Other information may also be included in this message, such as, but not limited to, type of data being shared, user preferences for the service, charging related information, (e.g., user acceptance for charging), local network name, CSG identity, HNB name, or any information as described herein. The other session or mobility management messages may also be used to indicate that a data sharing session is requested. For example, a WTRU may send a request to activate a dedicated bearer and may include additional IEs, as described herein above, to indicate to the network that a data sharing session is required. Thus, the same functionality may also be achieved with session management messages used for activating or modifying bearers, (may be with additional IEs as described herein above).

If the session is declined, the WTRU may receive a new NAS message indicating the rejection of the data sharing session. This indication may also be achieved by using an existing NAS message with additional or modified IEs. The message may include at least one of the following. The message may include the result of the session initiation request. In this case, the result may indicate the rejection of the request for data sharing. The WTRU, (e.g., the NAS layer), may indicate the result to the upper layers (e.g., the application layer). The message may include a reject code to indicate the reason why the session was rejected. Some reject causes may include: “Target WTRU rejection of session;” “Sharing not allowed for iWTRU or rWTRU;” “Sharing not allowed temporarily;” and “Session Timeout” or “Session Timeout due to rWTRU.”

For “Target WTRU rejection of sessions,” the iWTRU may initiate another session with the rWTRU in question, (may be after some time interval has elapsed). Alternatively, the iWTRU may not initiate a session with this rWTRU permanently, (this may be achieved with additional indication). Thus, the WTRU may temporarily add the rWTRU's identity to the list of forbidden WTRUs with which data sharing may be initiated. Alternatively, the WTRU may temporarily remove the rWTRU's identity from the allowed list if it is there. The modifications to the list may also be permanent, if indicated.

For “Sharing not allowed for iWTRU or rWTRU,” if sharing is not allowed for the iWTRU, the iWTRU may not initiate another sharing session with any other WTRU, (except for emergency related sessions), until informed by the network via NAS signaling or via OMA DA or OTA, or unless the network permits a terminated sharing with this WTRU. The WTRU may attempt initiating a session upon PLMN change, MME change, or the like, depending on network policies and WTRU configurations. If sharing is not allowed for the rWTRU, then the iWTRU may add the rWTRU's identity to the forbidden list, (and/or remove it from the allowed list). For “Sharing not allowed temporarily,” the WTRU may not initiate data sharing with any other WTRU, (except for emergency related sessions), until further indication from the network, (NAS signaling or via OMA DM or OTA), or until a terminated session request for data sharing is received. For “Session Timeout” or “Session Timeout due to rWTRU,” the WTRU may re-initiate the procedure/request. The carrying message may also include the identity of the rWTRU. A backoff timer may be included that may prohibit all mobile initiated requests for data sharing with all other WTRUs. All mobile initiated requests may be prohibited for data sharing with the rWTRU in question. The WTRU may take the actions above regarding modifying the lists.

Described herein are actions for the CN and RAN nodes. The following may be done by the CN, (e.g., MME or SGSN), when a request is received for a data sharing session. The message may be a new NAS message or may be an existing NAS message with additional or modified IEs. The message may include any combination of the information that is described herein above to be added by the iWTRU. The MME may verify if the requesting WTRU is allowed to initiate a data sharing session. For example, the MME may verify one or more of the conditions listed above. The MME may also verify if the rWTRU is allowed to engage in a data sharing session. Further, the MME may verify if the rWTRU is allowed to engage in a data sharing session for a specific type of traffic such as traffic obtained from an LGW, traffic obtained from a PDN GW in the CN, a specific traffic class, or the like. Thus, the MME may accept or reject the request from the iWTRU based on these criteria.

When the WTRU data sharing request includes either a request for a single WTRU or a request for any WTRU belonging to a specific group, the MME may verify that at least a WTRU from a list provided during the data sharing request is available and it has the right privileges for sharing. The MME may verify the location of the rWTRU before processing the request or before setting up resources for the session. The location verification may be done by paging the rWTRU. Alternatively, the rWTRU may already be in connected mode, and the MME may know the location of the WTRU at the cell level. In both cases, the MME may also verify if the WTRU is on a particular cell, (e.g., HNB or CSG cell), or if the WTRU is in a particular LN. Whether the rWTRU/iWTRU is allowed to have a data sharing service may depend on the location of the WTRU, (e.g., service may not be allowed on specific cells or locations or PLMNs).

The paging message (RRC) may contain a new CN domain indicator to indicate that the paging is due to data sharing. This indicator may be provided by the RRC to the NAS layer, and may include identification of the calling WTRU, (for example, the iWTRU that is initiating the data sharing session), and such information may be displayed to the rWTRU. The user may then choose to accept or reject the session for sharing data.

The MME may first page the rWTRU, (for example, if the WTRU is not already in connected mode), and then send an NAS message, (new or existing), that indicates the pending mobile terminated data sharing session. The identification of the iWTRU may be included in the RRC paging message or in an NAS message that may follow. This NAS message may also include other information such as the type of traffic, charging information, and indications of further actions to be taken by the rWTRU, for example. Also, an APN may be included to be used in the PDN connectivity request. Alternatively, such an APN may be well known and preconfigured in the WTRU or provided via OMA DM or OTA methods.

The MME may verify the availability of resources at specific nodes such as the cell that the iWTRU is on, the cell that the rWTRU is on, other nodes in the network such as LGW, SGW, HNB GW, and the like.

If the MME accepts the request based on the conditions, (for example, any combination of those listed above), affecting the iWTRU, (and also the rWTRU), the MME may reply to the iWTRU indicating the acceptance of the request. This may be done using a new NAS message or an existing NAS message, (for example, Evolved Packet System (EPS) Mobility Management (EMM) Information Request), with new IEs. This positive response may also indicate that the MME is in the process of contacting the rWTRU. The MME may then proceed to contact the rWTRU. Alternatively, the MME may first contact the rWTRU and, based on service conditions, (such as those mentioned above), that affect both the iWTRU and rWTRU, the MME may accept or reject the request. Thus, the MME may first confirm that both parties are allowed to get such a service before responding to the iWTRU. For example, the MME may verify that the rWTRU is allowed to receive such a service and may also verify that the user has accepted to receive shared data, before responding to the iWTRU.

The MME may accept the request, and it may also include any of the following in its response to the iWTRU: the identity of the rWTRU; the IP address of the rWTRU or the IP address that is to be used for data sharing, (this may have been sent by the rWTRU to the MME); a specific bearer to use for the data sharing; and any other information that may be useful for data sharing and may have been received from the rWTRU.

The MME may accept and setup resources for the data sharing after receiving a confirmation from the rWTRU that the session has been accepted by the user. The setup of the resources may be due to accepting a new NAS message for data sharing. Alternatively, the message may be an existing NAS message, (e.g., the PDN Connectivity Request with the modifications proposed above). The MME may take the following actions to setup resources if, for example, a PDN Connectivity Request is received, (however this may also be applicable to the case when other NAS (new or existing) messages are received).

The MME may send a Create Session Request message, (or a new message that may be defined for enabling data sharing), to the SGW in which the following information may be included by the MME. The information may include a new request type or IE to indicate that the session is for data sharing. The MME may replicate any of the information described herein to be included by the WTRU. The MME may also indicate if S5, (or similar resources between the SGW and PDN GW or between the SGW the LGW), may need to be established or not. A new indication may also be included to notify the SGW/LGW that the data on the bearer, (which is to be established), should not traverse beyond the LGW and should be mapped back to another bearer such that the iWTRU and the rWTRU may communicate.

The connection establishment may also be done via the establishment, (for example, by the WTRU), of a dedicated bearer or by modifying an existing bearer that is already established with the LGW, (for example, due to an existing LIPA PDN connection). In such a case, the MME may use the Modify Bearer Request toward the SGW. The MME may include information such as, but not limited to: the direction of the data sharing session, (for example, whether it is unidirectional from the one WTRU (for example, iWTRU) to another (for example, rWTRU), or if the data sharing may be bi-directional; and an identity for the session that may be uniquely assigned by the MME or by another entity in the network, (in which case the MME may not have it available at this stage of the signaling—for example, the LGW may assign this identity and pass it in the response back to the SGW/MME).

Upon reception by the SGW, this node may also send a Create Session Request, a Modify Bearer request or a new message, (that may clearly indicate a request for data sharing), toward the LGW. The SGW may differentiate such a request from a normal PDN connection request, (or bearer establishment or modification requests), due to the reception of either a new message from the MME or due to the inclusion of the IEs, (described herein above), in existing messages, (for example, Create Session Request/Modify Bearer request), that may have been sent by the MME.

Upon reception of a new message or existing message, (for example, Create Session Request or Modify Bearer Request), the LGW may use the fact that a new message is used or additional IEs are present in existing messages to identify that the request is for data sharing or any similar service. The message may also include an indicator that may be used by the LGW to not cause the traffic on the PDN connection or bearer (or flow) to traverse beyond the LGW towards a local. Thus the LGW may use any of the indications described herein to know that the traffic is not to traverse beyond the LGW. The LGW may also use the identity of the iWTRU and the rWTRU to map data from one bearer, (or flow or PDN connection), to another. The LGW may accept the procedure and respond accordingly, (for example, with a new message or an existing message with additional IEs), to indicate that the request is successfully executed. The LGW may additionally wait for the other party, (for example, the rWTRU), to establish a PDN connection, (or activate/modify a bearer), such that it may create a mapping between these two WTRUs for data sharing. Thus, it is expected that the other party, (for example, rWTRU), will eventually initiate such a request and the LGW will eventually receive the request in the same manner as described herein above. The LGW may then use the provided identities to create the mapping between the PDN connection or bearers of the two WTRUs such that data is mapped from one PDN connection (or bearer) in the uplink to another in the downlink, without traversing beyond the LGW.

The LGW may use any other identification that may have been included by the MME/SGW to create a mapping for data sharing between two (or more) WTRUs. For example, the MME/SGW may include a unique ID that identifies a data sharing session. This identity may be included in the resource allocation procedure for the iWTRU. The same identity may also be included in the resource allocation signaling for the rWTRU. Thus, the LGW may use such an identity to map which WTRUs, (or PDN connections, or bearers from WTRUs), are to engage in a data sharing session.

If the LGW accepts the request, it may respond back to the SGW/MME with an accept message, and may include, but is not limited to, the following information. For example, the information may include the identities of the rWTRU and iWTRU for which the resource/context is setup and a unique identity to identify the session. The unique identity may not be provided by the MME/SGW. Thus, the SGW/MME may use this identity to correlate it to the other request for resource setup by the other party, (for example, rWTRU if resources such as PDN connection or bearer have not yet been activated). Any such identity, (either assigned by the MME or SGW or LGW), may be provided to the participating WTRUs so that the sharing session may be identified. This may be included in any NAS messages that are sent to the WTRUs. The information may also include an indication to indicate that the corresponding bearer(s) are related to a data sharing session. Such indication may be forwarded to the RAN nodes and may be used by the RAN nodes to identify bearers for data sharing which may require different handling, (e.g., during handover).

The LGW may, upon receipt of the request from the SGW/MME, or after accepting (or processing) the request, (new message or Create Session Request or Modify Bearer Request), start a timer to guard a period during which a request may be received for the other WTRU, (or group of WTRUs), that are associated or are to engage in data sharing. For example, based on a session identity, (or any identification of another WTRU), the LGW may expect a request to set up resources for data sharing that is associated with an identified session or WTRU. However, this request may never arrive, (for example, if the rWTRU decides to terminate the request), and, thus, the LGW may send an indication to the MME that such a request did not arrive on time. This may trigger the MME to send an indication to the WTRU in question or to the WTRU that has already set up resources for data sharing. The LGW/MME may also decide to clear any resources that may have been allocated for a WTRU. This may also involve clearing up of resources at the RAN nodes by the MME.

If the LGW rejects the request, it may respond back to the SGW/MME with a reject message and may include the reason for the reject, (for example, “data sharing not supported”). The MME may then take further actions, such as rejecting the request that triggered the resource setup request with the LGW, (for example, the MME may in turn send a reject message to the iWTRU that may have requested this service).

Upon reception of an accept indication from the SGW/LGW for the setup of resources for data sharing, the MME may initiate the setup of resources toward the RAN node, (for example, toward the HNB). This may be done for all WTRUs that are involved (or to be involved) in a data sharing session. The MME may send an S1AP message to set up resources at the RAN node (for example, HNB) for data sharing. This may be done by defining a new S1AP message or, alternatively, an existing message may be used with indications that the resources, (for example, bearers), are to be used for data sharing. The message may include a unique session ID, or any of the identifications described herein above, that may be received by any node, (for example, any identification proposed to be received by the LGW). The identity of the iWTRU and the rWTRU may also be included.

The message may also include whether the data sharing is uni-directional, (and, if so, from which WTRU to which WTRU) or bi-directional; and the data path to be taken by the data, (for example, via the LGW or via another path). For example, both WTRUs may be in the same HNB and, therefore the data need not go via the LGW. Thus, such information may be provided to the HNB. Moreover, similar information that is described herein to be provided to the LGW may also be provided to the HNB. For example, the S1AP message may include information regarding whether or not the data should traverse beyond the HNB. Similarly, the HNB may use any provided identification to map bearers (or data) from one WTRU to bearers (or data) pertaining to another WTRU, (as described herein for the LGW case). The HNB may use any additional identification to tag the bearers such that they correspond to a data sharing session and, hence, they may be handled differently during mobility of the corresponding WTRUs.

The RAN node (for example, HNB), upon reception of a request to set up resources for data sharing, (either due to reception of a new message for this purpose, or due to the inclusion of new IEs as described above, for example, new IE to indicate resources are for data sharing), may then trigger an RRC procedure with the WTRU to set up radio resources for data sharing. The RRC message may include information such as the session identity, an indication that the radio bearer is for data sharing, the identity of the rWTRU, and the like.

The reception of such an RRC message in the WTRU may trigger the RRC to pass any new information to the NAS layer, (for example, any indication or identification that may have been included in the message). The NAS (or RRC) may further pass any such information to the upper layers. The NAS (or RRC) may also tag related bearers as those pertaining to data sharing and these bearers may require differentiated handling during mobility management procedures and handover.

The MME may respond to the WTRU that is associated with this request. The MME may send an accept response to the appropriate WTRU and may include any information that the LGW may have passed to the SGW/MME (for example, the MME may include a unique session ID that the LGW may have assigned). The MME may save any information that the LGW may have passed (for example, via the SGW) in the response message. Such information may be saved in the MME as part of the WTRU context.

The MME may also request the rWTRU, (or a group of rWTRUs), to initiate a PDN connection or bearer activation/modification with a particular APN. The MME may contact the rWTRU via NAS messages and may include information such as the iWTRU identity, the session identity, an APN name, and the like. Alternatively, the MME may perform a network initiated PDN connection setup or bearer activation/modification procedure and may indicate that the reason is for data sharing. The information described herein above may also be included to the destination WTRUs.

Upon reception of a reject indication from the SGW/LGW for the setup of resources for data sharing, the MME may reject the request from the WTRU as described herein below. The MME may include any cause code that may have been received from the SGW/LGW in the NAS message that may be sent to the WTRU. If the MME rejects the request based on the conditions, (for example, any combination of those listed above), affecting the iWTRU, (and also the rWTRU), the MME may reply to the iWTRU indicating the rejection of the request.

The reject message may be due to the reception by the MME of an indication from the rWTRU that the session was not accepted by the user. This indication may also include a cause code that explains the reason for the rejection.

The reject message that is sent to the iWTRU may include any combination of the following information. The reject message may include a reject cause to indicate the reason for declining the request, (this may simply be the same reject cause that was received by the MME from the rWTRU). The reject cause may be due to the type of application data to be shared not being accepted/allowed, the format of data not being allowed, the iWTRU, (also possibly rWTRU), not being allowed such a service (for example, it does not have a subscription), or the iWTRU/rWTRU is not allowed to have such a service in the current location, (cell, PLMN, location area, HNB, or the like.). The reject message may also include a backoff timer that may prohibit the iWTRU from contacting the rWTRU in question for the duration of the timer. The backoff timer may prohibit the WTRU from initiating further data sharing requests with other WTRUs for the duration of the timer.

Described herein are actions for the terminating WTRU. The terminating WTRU may refer to the rWTRU with which a data sharing session is requested by an iWTRU. The following may be performed by an rWTRU. The rWTRU may be paged with a paging message (RRC) that may include a new CN domain indicator that refers to a data sharing session or a communication with another WTRU, (or group of WTRUs). The RRC layer may provide this indication to the NAS, (for example, paging due to WTRU-to-WTRU communication or data sharing session). The WTRU may be in connected mode and may, thus, receive a new NAS message to indicate the terminating request for data session sharing. This may also be achieved via an existing NAS message with additional IEs.

The paging message and/or the NAS message may include any of the following information. The message may include an identification of the WTRU/user that is requesting the session. Such identification may be provided to upper layers/users so that the upper layers/users may decide on accepting or rejecting a request. Furthermore, the identification may be used to verify if the user does not wish to have a data session with the WTRU in question. This may be done by verifying the identity with a list of WTRUs that hold identities with which the rWTRU/user may not wish to have a data sharing session. Thus, the NAS or upper layers may use this identity to verify it exists in the WTRU's “list of WTRUs with which data session sharing is not desired”. If yes, the WTRU may then reject the response according to the proposals herein. The message may also include the initiating WTRU's identity with any other information, (for example, data format to be shared, charging information (i.e. whether the recipient WTRU will be charged for the session) or the like). The NAS message (or paging message) may also include information about the type of data to be shared, (for example, local in the iWTRU), or data that is being downloaded from the LGW, or the like. The NAS message (or paging) may include any of the information described herein to be sent by the iWTRU's request as listed previously.

Based on WTRU configurations, or based on user input request, (for example, via display), the WTRU/NAS may respond to indicate whether or not the request is accepted. The response may be a new NAS message or an existing NAS message with additional IEs. The message may also include the WTRU's response regarding whether such a session is accepted or not. If the request is rejected, the message may also include a cause code to indicate to the network the reason for rejection. For example, the user may have rejected the session because the request is from a particular WTRU, and the user might have been requested to “Accept,” “Reject,” or “Reject from this user.” The reject message may also indicate a timer during which the rWTRU does not want to engage in data sharing. This timer may be specific to the requesting WTRU (iWTRU) or for all WTRUs. The scope of the timer, (for example, applicability to all WTRUs or the iWTRU in question), may also be included in the reject message.

If accepted by the WTRU, the NAS message may indicate the acceptance of the request and may also indicate additional information, (for example, data format, application type, or the like). A time interval may also be included to guard duration for data sharing after which the WTRU may not be available for data sharing. This may be based on WTRU configurations or user input and modification to WTRU settings. The accept message from the rWTRU may also include an IP address to be used for the data sharing. The accept message may also include other information relevant for data sharing

The WTRU may set up a PDN connection in response to the acceptance of the data session sharing. Alternatively, a PDN Connection Request message may actually be used to indicate that a data sharing session is accepted. The following modifications may be done to the PDN Connection Request message: a new PDN request type, or an APN may be left blank or may be set to a specific value. The identity of the accepting WTRU may be included in this message as well. Also, the identity of the initiating WTRU may be included, and this may be retrieved from the indications described herein above, (for example, from messages that were sent to the rWTRU where such an identity is proposed to be included).

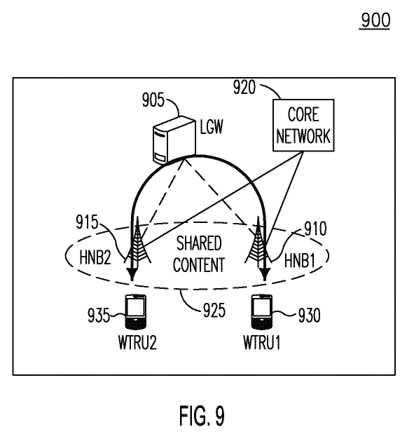

FIG. 9 is a diagram of a LIPA implementation 900 showing how the embodiments described above with respect to FIGS. 4-8 may be used. This example is not intended to limit the proposals above and illustrative. Other combinations may also be possible. LIPA implementation 900 includes a LGW 905. A pair of HNBs 910 and 915 may be connected to the LGW 905 and to a CN 920. A local network (LN) 925 may be defined as the coverage area defined by HNBs 910 and 915. WTRU1 930 and WTRU2 935 are in the LN 925. WTRU1 930 may have local data that it wants to share with WTRU2 935, and WTRU1 930 may have discovered WTRU2 935 using methods described herein above and, thus, WTRU 930 is already aware of the location of WTRU2 935.

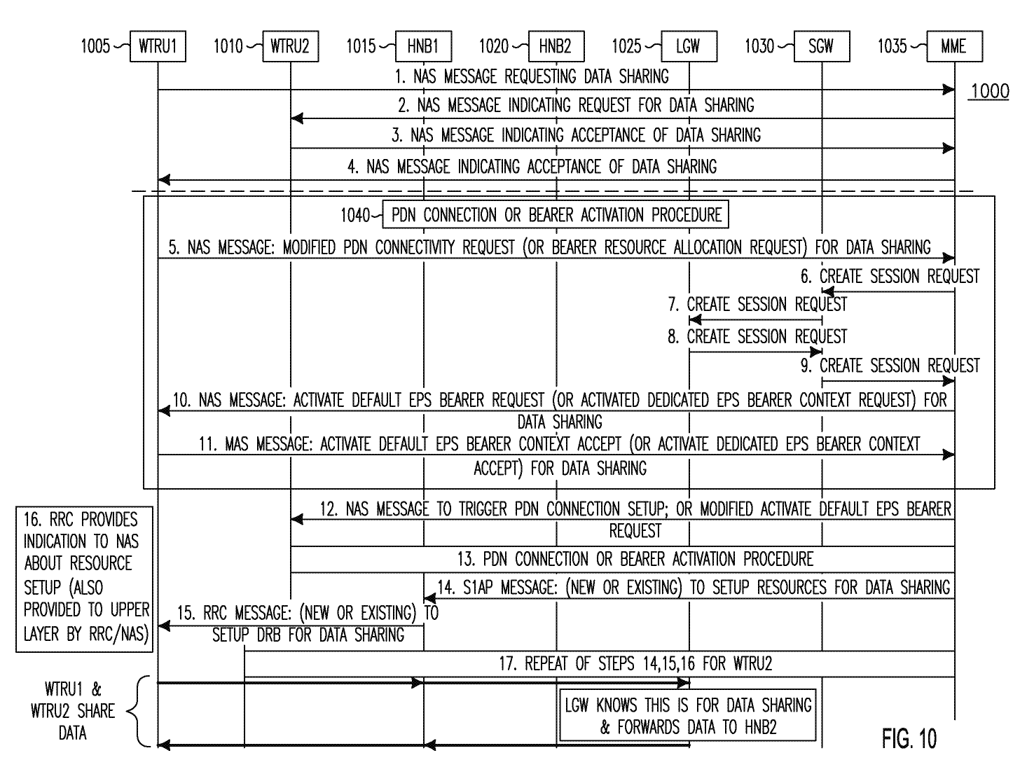

FIG. 10 is a flow diagram 1000 of the example implementation illustrated in FIG. 9. The flow diagram 1000 shows flow between a WTRU1 1005, WTRU2 1010, a HNB1 1015, a HNB2 1020, a LGW 1025, a SGW 1030 and a MME 1035. WTRU1 (iWTRU) 1005 sends an NAS message, (for example, due to a trigger), to the MME 1035 for the purpose of sharing data with another WTRU, for example, WTRU2 1010 (1). WTRU1 1005 may include all necessary information about the target WTRU (rWTRU) and/or application in this message. The MME 1035 may receive the message and verify whether the iWTRU/rWTRU is allowed to receive such a service. The MME 1035 may forward the message to the rWTRU (for example, WTRU2 1010), to indicate that another WTRU wants to start a data sharing session (2). The MME may include all necessary information about the iWTRU and/or application in this message, (or any other information as described above).

The rWTRU 1010 may receive the request and, based on WTRU local policies or user input, may respond with an NAS message to the MME 1035 indicating the acceptance of the request to share data with the iWTRU (3). The MME 1035 may respond to the iWTRU 1005 indicating that the rWTRU 1010 has accepted the request for data sharing (4). A PDN connection 1040, (or a new bearer or a modification of an existing bearer), may be activated for the purpose of data sharing. The messages may include any of the information listed above. In particular, this may include iWTRU 1005 sending a NAS message having a modified PDN Connectivity Request, (or Bearer Resource Allocation Request), for data sharing (5). The MME 1035 may then send a Create Session Request to the SGW 1030 (6), which in turn sends the Create Session Request to the LGW 1025 (7). The LGW 1025 sends a Create Session Response back to the SGW 1030 (8), which in turn sends the Create Session Request back to the MME 1035 (9). The MME 1035 then send a NAS message including an Activate Default EPS Bearer Request, (or Activated Dedicated EPS Bearer Context Request), for data sharing to the iWTRU 1005 (10). The iWTRU 1005 then sends a NAS message including an Activate Default EPS Bearer Context Accept, (or Activated Dedicated EPS Bearer Context Request Accept), for data sharing (11).

The MME 1035 may request the rWTRU 1010 to establish a PDN connection for data sharing, (or establish a bearer or modify a bearer) (12). The rWTRU may perform a PDN connection setup request (or establish a bearer or modify a bearer) for data sharing (13). This may involve steps similar to (5)-(11) described herein above. The MME 1035 may inform the HNB1 1015 to set up resources for data sharing for the iWTRU 1005 (14). The MME 1035 may provide an indication in the S1AP message that the bearer to be established is for data sharing. The HNB1 1015 may configure the iWTRU 1005 to establish a data radio bearer (DRB) for data sharing and may also indicate to the iWTRU 1005 that the bearer is for data sharing (15). The RRC may indicate to the NAS that a bearer has been established for data sharing (16). The S1 and radio resources may be set up for the rWTRU, for example, as per (14)-(16) (17). Both WTRUs may now send data to each other via the LGW 1025, which knows that the established bearers contain data that is to be shared between two WTRUs and, hence, the LGW 1025 may map data received from one bearer from one WTRU to another bearer for another WTRU without making the data traverse past the LGW 1025.

All of the embodiments described herein above may also be used to share data with a group of WTRUs that may be in the same LN.

Described herein are methods to terminate/modify a data sharing session based on WTRU and/or network impacts. The term modification may refer to termination or modification of a session such that a WTRU may be added to a data sharing session or that a WTRU may be removed from a data sharing session. Alternatively, it may refer to suspension of a data sharing session or to the resumption of a data sharing session. The content may be shared between the iWTRU (the content provider) and multiple rWTRUs (the content receiver). Also, between one iWTRU and rWTRU, there may be multiple shared sessions. Each of the shared sessions may be identified by a shared session ID. For each shared session, the CN may maintain a shared session context that may include any of the following information (but not limited to this list): shared session ID (or session ID); the iWTRU ID, the rWTRU ID, a group of iWTRU IDs, or a group of rWTRU IDs, the EPS bearer context ID of the iWTRU and the rWTRU per session, (there may be multiple bearers per session); the access right of the iWTRU and the rWTRU, (for example, read/write/read+write, and the like); and other information related to service continuity (for example, if the session is allowed to be maintained if any of the WTRUs move from their given location, where location may refer to a cell, (for example, a HNB), a local network, LGW coverage, or beyond).

The termination/modification of a data sharing session may be initiated by, (based on operator rules which may be applicable on a per session basis): the iWTRU only; the rWTRU only; or either the iWTRU or the rWTRU, (any of this may be due to a user intervention via the user interface); or the network (for example, CN nodes or HNB nodes).

The following triggers may be defined for termination/modification of a data sharing session: the user intervention may trigger a termination/modification of a data sharing session; mobility of the iWTRU, rWTRU, out of the LN coverage, HNB coverage area, or LGW coverage area, (for example, for termination); mobility of the iWTRU or rWTRU into the LN coverage, HNB coverage area, or LGW coverage area may trigger the resumption of a data sharing session; lack of resources at the RAN nodes, (for example, HNB or LGW); expiry of CSG access permission or change of a HNB mode from CSG to hybrid or vice versa; expiry of a data sharing session lifetime timer that may be run in the CN nodes, RAN or WTRUs; the CN may inform the WTRU, (iWTRU, rWTRU, group of iWTRUs or group of rWTRUs), that a session has terminated/modified or should be terminated/modified, (the receiving WTRU may then take the actions described herein below to terminate/modify a session); the CN is informed about WTRU mobility, (for example, by the RAN nodes); the RAN node (for example, given it already knows about a data sharing session, (as described herein above))—the RAN node (for example, a HNB) may be configured to request termination of data sharing when a WTRU moves from one cell/area to another cell/area or RAT, or the like; the rWTRU or iWTRU sends a request to detach from the system; and/or the rWTRU or last rWTRU or iWTRU goes to idle mode, (i.e. upon connected to idle mode transitions).

Described herein are actions that may be taken by the WTRU, (for example, iWTRU, rWTRU or both), for the purpose of terminating or modifying a data sharing session. The actions may also be applicable to the case where, for example, an iWTRU is sharing data with a group of rWTRUs, and a specific rWTRU is to be dropped from the data sharing session. The actions may be taken due to any of the identified triggers above.

The WTRU may send a new NAS message or an existing NAS message with additional/new IEs. In an example, the new NAS message that may be used to set up a data sharing session may also be used with a different value for the requested action such that the value indicates a termination, a modification, or resumption. The message, (new or modification of an existing NAS message), may indicate the following. This message may be sent by the WTRU either because the WTRU in question would like to terminate a session or because the WTRU may have received an indication to inform it that the session has terminated. Hence, the WTRU may follow up with this message to clear the resources with the network. The message may indicate that the action requested by the WTRU, (for example, termination, modification, (which may include additional details about the required modification (for example, addition of a flow, or the like)), suspension, resumption, removal of a WTRU in question from a group data sharing session, (for example, where the WTRU to be removed may be the same WTRU sending the request, (a WTRU wants to leave a group session)).

The message may indicate the identity of the WTRU sending the request, (for example, where any of the identities described herein may be used). The message may also indicate the identity of the rWTRU with which a session may be active, (or may have been previously established). The request may also include an identity of a group of WTRUs, (for example, a group of rWTRUs), that may be involved in a data sharing session. The message may also indicate a session ID or a group session ID. All the information that was described herein to be added for establishing a data sharing session may also be included here. Further, any information that the WTRU, (for example, iWTRU or rWTRU), may have received during the establishment of a session may also be included in this message.

The message may also include a timer indicating when a WTRU, (for example, iWTRU, rWTRU or group of rWTRUs), may be dropped from the session. For example, at the expiry of this timer, the network may initiate the termination of a particular WTRU from the session in question. Thus, an identity of a WTRU may be associated to such a timer. The message may also include a packet filter or flow identity that may indicate a flow that is to be dropped from a data sharing session that may involve multiple flows. The message may also include a cause code for dropping the terminating/modifying session. The message may also include a session duration and information about the total volume of data shared, (for example, number of bytes or similar parameters). The WTRU may also locally deactivate related bearers and may display to the user or provide upper layers with an indication that the session has terminated/been modified. The message may also include any readable message to the rWTRU for display purposes.

The termination or modification of a session may also be achieved by using NAS session management messages such as PDN Disconnect Request, Deactivate EPS Bearer Context Request or Modify EPS Bearer Context Request. All of the embodiments described above may also be included in these messages as new IEs. This message may be sent by the WTRU either because the WTRU in question would like to terminate a session or because the WTRU may have received an indication to inform it that the session has terminated. Hence, the WTRU may follow up with this message to clear the resources with the network, or to confirm that the WTRU has terminated the session. The WTRU may also locally deactivate related bearers and may display to the user, or provide upper layers with, an indication that the session has terminated/been modified. The additional information proposed above may also be included in this message.

The following actions may be taken by the CN nodes, (for example, upon reception of a request to terminate a session, (or drop a WTRU from a session)), or, for example, upon the occurrence of any of the triggers described herein above. The CN node, (for example, the MME), may send an NAS message to a WTRU indicating acceptance or rejection of the request, (for example, that may have been received from an iWTRU), to terminate or modify the session. The responses from the MME that were described herein above to set up a session may also apply here but for the purpose of terminating/modifying the session. Thus, the MME may either accept or reject the request and may respond accordingly with an appropriate cause code.

The MME may also receive the identity of the iWTRU and rWTRU or the identity of the rWTRU that should be removed from the session. The MME may clear all of the resources for the session if the rWTRU to be removed is the last rWTRU. This message may be sent to a WTRU that requested the termination of a session, and the response from the MME may indicate whether the MME accepted or rejected the termination/modification request. The message may be sent before or after taking the necessary actions, (for example, clearing up resources in case of termination), with other nodes, (for example, HNB/SGW/LGW, and the like).

The MME may also notify a WTRU, (for example, an rWTRU), via new or existing but modified NAS message, (such as session management messages to deactivate/modify a PDN/EPS bearer), about the (potential) termination/modification of a session. The MME may include information such as those described herein above to be used in setting up a session, (for example, session ID, iWTRU, rWTRU, or the like). A cause code for terminating/modifying a session may also be included. Also, a request type may be set to indicate session termination/modification/and the like. The message may also be sent to at least one rWTRU, all of the rWTRUs, and/or the iWTRU, that may be involved in the data sharing session.

This message may be sent due to any of the triggers defined above for session termination/modification (for example, if the MME receives a request to modify/terminate a session with at least one WTRU, then the MME may send this message to inform the other WTRUs to modify/terminate the session accordingly). The message may include a value for the expected action (for example, modify/terminate/suspend, or the like). The operation may be guarded by a timer at the CN. If the timer expires before the action is executed by a WTRU, the MME may then terminate the session for that WTRU.

The message may also include details of a potential modification procedure. The message may include any information that may have been received from a WTRU that triggered the sending of this message by the MME to other WTRUs.

The MME's message to the WTRU may be due to a CN trigger to terminate a session or may be due to the reception, (for example, by the MME), of a message, (may be from another WTRU), requesting the termination of a session between at least two WTRUs. The following additional information may also be included: the duration of the shared session; total bytes transmitted, (or other similar parameters); and charging information. The cause code may include “WTRU no longer available”, (may be with the identification of the WTRU); “Session duration terminated”; and the like. The information may be sent to the rWTRU and/or the iWTRU.

The recipient WTRU may, as a result, send an NAS message requesting the termination of the shared session. If the termination/modification of the session is accepted in the MME (for example, based on subscription information for session termination/modification or based on operator rules for termination/modification), the MME may contact the SGW/LGW to clear/modify resources accordingly. The MME may include any identification information (for example, as those described herein above for setting up a data sharing session). This action may be done for every WTRU that is involved in the data sharing session.

The MME may also indicate if the request is to terminate the whole session or to drop a flow, a bearer, or a WTRU from a session. The SGW may forward any such request to the LGW and may include any information that may have been received from the MME. The SGW may clear/modify the resources accordingly. This may be, for example, after a response from the LGW.

The LGW may clear/modify the resources accordingly based on the received indications: the LGW may clear all the resources if the request indicates termination of the whole session; the LGW may clear certain flows if the request indicates termination of a specific flow; and the LGW may clear resources related to at least one WTRU as identified, for example.

The LGW may then respond with the result of the operation and an appropriate cause code (for example, successful termination of the session). The MME may then, upon receipt of a result from the SGW/LGW, indicate to at least one WTRU the result of the operation or notify at least one WTRU that such an operation has taken place. This may be done with new or existing NAS messages.

If the termination/modification procedure affects at least one rWTRU, the MME may notify at least the iWTRU, (and other WTRUs, if appropriate), about the procedure outcome of the rWTRU(s) in question. For example, if one rWTRU requests termination of the session, the MME may, after processing the request (for example, either accepting it or rejecting it), inform all other WTRUs about the event and the outcome, and the reason, for example, as may have been provided by the rWTRU.

If the termination/modification of the session is accepted in the MME, (for example, based on subscription information for session termination/modification or based on operator rules for termination/modification), the MME may request the RAN nodes that are involved in data sharing to terminate/modify the resources accordingly. The MME may do this after receiving and requesting the SGW/LGW to take an action, (for example, terminate a session), and may do this after receiving a response from the SGW/LGW about the successful termination of a data session. This may be done using a new S1AP message or an existing S1AP message with new IEs. The embodiments introduced earlier to setup a connection may also be used here to terminate/modify a connection.

For example, the MME may request at least one HNB, (and all others that are involved in the data sharing session), to terminate/modify resources for the identified WTRU(s), session ID, and the like. All identification or information that was used as described herein above for session setup may also be used in the procedure/signaling for session termination/modification.

The RAN nodes may in turn trigger RRC procedures to clear/modify resources, (or WTRU configurations), with the WTRU. The RRC message, (new or existing), may include any cause code that may have been received in the S1AP messages from the MME.

The RRC layer in the WTRU may pass any indication, (for example, termination/modification of configurations/resources (radio bearers)), to the NAS layer. The RRC or NAS layer may further pass such information to upper layers, (for example, applications using the data sharing feature).

The methods described in WO 2012/135793 A2, “Local/Remote IP Traffic Access And Selective IP Traffic Offload Service Continuity”, with regard to LIP/SIPTO session continuity are applicable herein to data sharing, and WO 2012/135793 A2 is herein incorporated by reference.

Referring to the embodiments illustrated in FIGS. 5 and 7, (or to any embodiment in which one WTRU attempts to share data that is being downloaded from an IP network, (either an IP connection to the Internet or a local IP connection as in LIPA), via a PDN GW or an LGW)), the WTRU may share the data in accordance with the following example.

A WTRU (iWTRU) may send an NAS message to the MME to inform it that it would like to share data with another WTRU (rWTRU). The iWTRU may indicate the identity of the rWTRU. In an example, the iWTRU may also indicate the application ID, port number that issued by the iWTRU and any other information that is relevant to setting up a connection directly with the IP peer in the Internet, (or local IP network), from which the iWTRU is receiving the downlink IP data.

The MME may send an NAS message to the rWTRU to inform it about the request and, may request the rWTRU, (or other user), to accept or decline the session. The MME may forward all of the information listed above to the rWTRU. The MME may also indicate the identity of the iWTRU that is requesting this service. The rWTRU may be configured with policies that allow it to accept or decline the request. This may also be done using inputs from the user. The WTRU may send this information to upper layers, (for example, the appropriate application as identified by the application ID, which may display the request to the user or the display may also be done by the NAS). The MME may also provide an indication to the rWTRU to initiate the activation of dedicated bearer or modify a particular bearer that may already be established by the WTRU. The MME may also include the required QoS to be requested.

The rWTRU may send an NAS message to indicate response from the rWTRU as per its local policies or as per the user input. The rWTRU may also directly initiate the activation/modification of a bearer as per the included QoS that is received from the MME.

The MME may initiate a procedure to establish or modify a dedicated bearer to meet the QoS of the bearer whose data is to be shared. For example, the MME may start a network initiated request towards the rWTRU for the purpose of establishing a dedicated bearer. The MME may also indicate that the bearer is used for data that is shared from another WTRU's connection.

While setting up resources with the SGW or PDN GW, the MME may indicate that the resource/bearer is used to share data from another WTRU (iWTRU). The data sharing here may be different from data sharing described above (for example, where data from one WTRU is sent to the other WTRU). In this case, the MME may explicitly indicate sharing in the form of data bicasting from a specific entry point towards at least two WTRUs, (the embodiments described herein may apply to data sharing between more than two WTRUs). The term “entry point” may refer to the node at which bi-casting is implemented.

Thus, the MME may indicate, (for example, to the SGW/PDN GW), the identities of both the iWTRU and the rWTRU, (and other WTRUs if there are more involved in the data sharing). The MME may indicate, for example, the entry point from which data is to be bi-casted. This may be the SGW or the PDN GW. If the bi-cast is to start from the SGW, the SGW may still inform the PDN GW about the sharing so that charging may take place. Alternatively, the SGW may not inform the PDN GW and may take the actions described below for the purpose of bi-casting data for at least two WTRUs. If bi-casting is to start from the PDN GW, the SGW may inform the PDN GW about the bi-casting and identify the impacted WTRUs for which bi-casting is to be done as described below.

The MME may indicate whether the rWTRU is in a local network and, as such, may include an LGW address so that the SGW may forward data to the LGW for the rWTRU. The MME may initiate a different Create/Modify Bearer Request for an rWTRU that is part of a local network. This may be done so that the SGW may inform the LGW about the data forwarding. Thus, upon reception of this indication or message, the SGW may also send a Create/Modify Bearer Request to the LGW and inform it about data to be forwarded from the SGW. The SGW may also include the identity of the rWTRU that is impacted by this procedure.

The LGW may respond to the SGW's request and may accept it. The LGW may then forward any data from the SGW to the rWTRU in question. The MME may also indicate the bearer ID of the iWTRU from which data should be replicated/bi-casted to the bearer of the rWTRU.

In the embodiments described herein, data sharing may be done for specific IP flows and, hence, the WTRU may always provide the appropriate information that would identify the set of flows that should be shared, where the flows may belong to different bearers. The iWTRU may provide IP address, and port numbers of source/destination for which data is to be shared. Alternatively, the iWTRU may provide packet filters or Traffic Flow Template (TFTs) that identify the flows that should be shared. Upon reception, the MME may forward all of this information to the SGW/PDN GW so that these nodes may identify the flows that should be shared with other WTRUs. Thus, in the embodiments described herein, embodiments for data sharing may also apply to IP flow sharing. This may be done by including new information elements in the Create Bearer Request or Modify Bearer Request that is sent from the MME to the SGW and also from the SGW to the PDN GW.

The MME may also indicate the bearer of the rWTRU that should be used for forwarding the data to the rWTRU. Alternatively, the SGW may choose the appropriate active bearer for the rWTRU if one already exists. New IEs may be used for this purpose. If an appropriate bearer does not exist, (for example, the rWTRU does not have a bearer that matches the quality of service (QoS) for the data to be shared), the MME may request the WTRU to establish a new bearer or modify an existing bearer. The MME may also initiate a bearer activation or modification toward the WTRU.

The SGW/PDN GW may use these indications to mimic or bi-cast data intended for the iWTRU's identified bearer/flow to both the iWTRU's identified bearer and the rWTRU's newly identified/created/modified bearer. The SGW/PDN GW may store an indication per bearer so that it knows if data should also be copied or bi-casted to other bearers. Part of the WTRU's context information, (for example, iWTRU and/or rWTRU), may include this information. For example, when the SGW/PDN GW receives data from an IP network, the SGW/PDN GW may verify the WTRU's context and, based on any saved indication/information, the SGW/PDG GW may forward the data to both the iWTRU and at least one rWTRU. The SGW/PDN GW may replicate the data intended for the iWTRU's bearer to also forward it to the established bearer for the rWTRU.

The context information for one WTRU may define whether its data should be forwarded to another WTRU or if the WTRU is to receive data from another WTRU. Hence, such indications may be part of both the iWTRU and/or the rWTRU context information.

The system may choose that the PDN GW is the node where data is bi-casted on at least two different bearers for different WTRUs. Alternatively, this function may be implemented at the SGW. If data is bi-casted at the SGW, the system may still establish an S5 bearer for the rWTRU even if no data is transmitted on that bearer.

Also, regardless of where data bi-casting functionality is implemented, (for example, at the SGW or PDN GW), the data may be sent to an LGW where an rWTRU may be located or may have a PDN connection. For example, the rWTRU may be in a local network, for example, in a CSG cell), which may have a direct connection between the RAN and the LGW (for example, as in the case of LIPA). Thus, the data may be sent from an SGW to an LGW and then from the LGW to the rWTRU.

The system may charge the iWTRU a rate for sharing the data with a peer WTRU. The system may charge the iWTRU more than the normal rate that would have been charged for setting up a bearer that is not for data sharing. The iWTRU may inform the system that any charges on the rWTRU should instead be charged to the iWTRU. The rWTRU may accept such a data sharing service if the rWTRU is charged for the session.

The steps described above may be performed in any order using any combination. Further, for the embodiments described herein, the iWTRU may include information about the location of the rWTRU, which may be in the form of an LN identity, CSG name, HNB name, WTRU data sharing identity, and the like. This information may be provided in the NAS message that the iWTRU sends to the MME.

Referring to the embodiment illustrated in FIG. 6 in which both the iWTRU and the rWTRU are in different LNs or to any embodiment where both WTRUs are under the coverage of different LGWs and/or different HNBs (or HeNBs), the WTRUs may share the data in accordance with the following example. Other methods, procedures and actions for different network nodes described above may also be applicable with respect to this example.

When the MME receives a PDN connection request from the iWTRU and/or rWTRU, it may observe from the information, (for example, the LGW ID, LGW address, CSG ID, address of the target/peer WTRUs as mentioned and/or some special indication in the PDN connection request messages), that both WTRUs belong to different local networks or are under the coverage of different LGWs. Also, the iWTRU may contain information about the identity of the local network in which the rWTRU is in. If so, the iWTRU should include this information in the NAS message that is sent to the MME.

The MME may hold information about location of WTRUs in local networks. For example, a local network ID as provided by the iWTRU may indicate to the MME that an rWTRU is in a different local network. The iWTRU may also include information in the NAS message about its own local network in which it is currently being served. The MME may hold mapping between WTRU identities and local network, (and hence LGW), identities. For example, the iWTRU identity may be affiliated with LGW X, for example, while the rWTRU's identity, (that may be included in the NAS message), may be affiliated with, (and hence maps to), LGW Y, for example. Thus, the MME may realize that both the iWTRU and the rWTRU are under different LGWs.

The MME may indicate to the SGW and/or the LGW that a tunnel needs to be established with another LGW. To do so, the MME may include an indication in the Create Session Request, (or Modify Session Request or any other message that is sent to the SGW/LGW), that is sent to the SGW. This indication may be a new IE that specifies that the LGW needs to establish a connection with another LGW. The MME may also include the LGW address or identification such that the target LGW may be inferred from this identification. The SGW may also forward the indication(s) to the LGW. The MME may also indicate that the reason for establishing this tunnel is for data exchange between at least two WTRUs in different LGWs. The MME may also include a bearer ID that identifies the bearer whose content should be forwarded to another LGW. The MME may also include packet filters to identify flows that should be forwarded to another LGW, (for example, for data sharing). The MME may also include the identities of both the iWTRU and the rWTRU in its message to the SGW/LGW.

Upon reception of a message such as (but not limited to) Create Session Request with a new indication as described herein above, the LGW may use the target LGW identification to infer the target LGW address, (for example, using Fully Qualified Domain Name (FQDN)). The message may optionally include the address of the target LGW.

The source LGW may then establish a connection with the target LGW using the interface that connects both nodes. For example, the LGW may send a message called “Create Tunnel Request” and may indicate that the reason is for data sharing. The LGW may include the rWTRU identity in this message, (for example, if received from the SGW/MME). The source LGW may include a tunnel endpoint ID (TEID), internal/external IP addresses and/or another transport layer address that should be used for data forwarding by the target LGW.

The target LGW may first confirm with the MME whether a session/connection/tunnel should be established with the source LGW. The LGW may also request the rWTRU's bearer or flow, (for example, in the form of packet filters), whose content should be forwarded to the source LGW. The target LGW may first contact the MME before responding to the source LGW request. Alternatively, the MME may already contact both LGWs and may provide the target LGW with all the required information, (for example, source LGW address, iWTRU and rWTRU identities, bearer and/or packet flow, (TFT or packet filter), information, and the like).

By default, the source LGW may contact the target LGW. Alternatively, the target may contact the source LGW or the MME may provide an explicit indication to the source or target LGW to contact its peer LGW. The MME may confirm to the target LGW that a tunnel should be set up with its peer LGW. The MME may also provide the target LGW with information about the rWTRU and/or the rWTRU's bearer, (or IP flow such as packet filters), whose content should be forwarded to a peer LGW. The MME may also provide an indication that this tunnel is for data sharing.

The target LGW may respond to the source LGW with an accept/reject accordingly. If accepted, the target LGW may include a TEID, internal/external IP addresses and/or other transport layer address that should be used for data forwarding by the source LGW. The target and/or the source LGW may send an indication to the MME to confirm the establishment of a tunnel between the two LGWs. Bearers may not have been established for the WTRUs, and the MME may indicate to each WTRU to establish a bearer for data sharing. The MME may then indicate the bearer ID to each LGW, (and/or the packet filters or IP flows), whose content should be forwarded to the peer LGW. Alternatively, the LGWs may initiate a bearer activation or modification for this purpose, (for example, to activate packet filters that use an already established bearer or to activate new bearers for data sharing).

The source LGW, the target LGW and/or the MME may indicate to the charging system that resources have been established or may indicate the volume of data transferred on the established connection between the LGWs so that the WTRUs may be charged accordingly. This inter-LGW connection may need to be torn down when one of the WTRUs involved in the data sharing moves away from its local network or when its type of data sharing connection is disconnected for some other reason. In such a situation, when the MME sends a delete session request message to the SGW, it may include an indication or a new IE in this message suggesting that the inter LGW connection may also be torn down. The SGW may then forward this delete session request message with this new IE to the LGW. The LGW may then use this indication to remove the context of the other LGW and disconnect the inter-LGW connection. This may also be done when any of the WTRUs request the deactivation or termination of the data sharing session.

The MME may send each LGW, (may be via the SGW using a Bearer Modification Request or a new message, for example), a message to deactivate the data sharing or to deactivate the established LGW-to-LGW connection for the WTRUs in question. The source and/or target LGW may initiate the deactivation of the established connection for the session in question using new messages on the interface that connects both LGWs. The sender may indicate that the reason is due to a termination of data sharing or due to WTRU mobility, (for example, as provided by the MME). The source and/or the target may clear the resources used for this session. The source and/or the target LGW may indicate to the MME that the connection has been terminated for the session (or WTRUs) in question. The LGWs may indicate to the charging system that the session has terminated so that charging may be stopped.

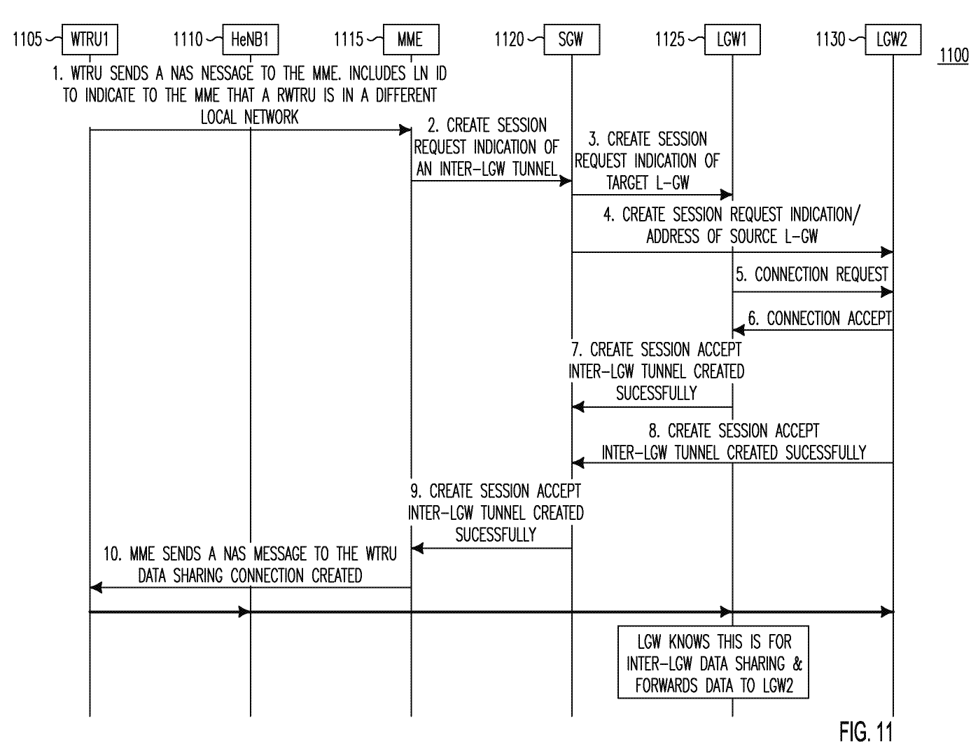

FIG. 11 is a diagram 1100 of an example signaling flow for connection setup for embodiments such as the embodiments illustrated in FIGS. 5 and 7 or any embodiment in which one WTRU attempts to share data that is being downloaded from an IP network, (either an IP connection to the Internet or a local IP connection as in LIPA) via a PDN GW or an LGW). It may be assumed that both WTRUs are under different local networks, but they may be connected to the same MME and SGW.

In the illustrated embodiment, the example signaling flow may be between a WTRU 1105, a HeNB 1110, a MME 1115, a SGW 1120, a LGW1 1125 and a LGW2 1130. The WTRU 1105, (also iWTRU), sends a PDN connection request, which may include information such as its local network ID, LGW address, CSG ID, the address of the target/peer WTRU and/or may be some special indication in the PDN connection request messages that are used by the MME 1115 to determine whether both the iWTRU 1105 and rWTRU belong to different local networks or are under the coverage of different LGWs (1). The iWTRU may also include the rWTRU's local network ID, CSG ID, and the like.

The MME 1115 may send the Create Session Request message to the SGW 1120, which may include an indication to the SGW 1120 that a tunnel needs to be established with another LGW, for example, LGW2 1130 (2). This may also be applicable to other messages sent to the SGW 1120, (for example, Modify Bearer Request). The SGW 1120 may forward the Create Session Request message to LGW1 1125 and include information about the target LGW to contact, for example, LGW2 1130 (3). The SGW 1120 may also identify both the iWTRU and the rWTRU. The MME 1115/SGW 1120 may also contact LGW2 1130 and provide all the required information required, (for example, source LGW address, iWTRU and rWTRU identities, and the like) (4).

LGW1 1125 may then establish a connection with LGW2 1130 using the information provided by the MME 1115/SGW 1120 in the previous steps (5). LGW2 1130 may respond to LGW1 1125 with an accept message accordingly (6). LGW1 1125 may also identify the iWTRU and the rWTRU for which this procedure is performed.

Both LGW1 1125 and LGW2 1130 may then send Create Session Response messages to the SGW 1120 informing that the inter-LGW tunnel has been successfully created (7 and 8, respectively). The LGWs may each identify the iWTRU and the rWTRU that are related to this procedure. The SGW 1120 may then forward this Create Session Response message to the MME 1115 (9). The SGW 1120 may inform the MME about the success of the connection between LGW1 1125 and LGW2 1130. At this point, all of the connections on the core network have been established, and the MME 1115 may now accept the WTRU's connection request and follow the steps required for PDN connection or connection setup completion as described herein (10).

The MME 1115 may send a Create Session Request to the SGW 1120 for each LGW. Hence the SGW 1120 may in turn send a message, (for example, Create Session Request), to each LGW after receiving the corresponding message from the MME 1115 for the LGW in question.

Described herein is discovery of WTRUs in local networks. With respect to embodiments described herein, “local network” may refer to any of a set of CSGs/HeNBs that share the same local network ID, (not necessarily CSG ID but may also be a CSG ID), or a set of LGWs that may or may not connect to the same APN. CSG/HeNB cells may connect to multiple LGWs. Thus, a local network (LN) may also refer to a connection between a set of CSG/HeNB and an LGW.

In an embodiment, the following may be performed for discovery of WTRUs in local networks. The MME may inform all WTRUs in a local network when a WTRU enters, (as part of idle-to-connected mode transition or handover), or leaves the LN. This may be done with new NAS or RRC messages, via higher layer protocols, such as Access network discovery and selection function (ANDSF), SMS, and the like. For example, when a WTRU enters a CSG cell that is part of an LN, the MME may inform all the WTRUs that are in that LN, (or that are in connected mode), that a new WTRU has entered the area. The MME may inform all WTRUs that are connected to a particular LGW or a set of LGWs with data sharing enabled when another WTRU establishes or terminates a PDN connection with that LGW.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals, (transmitted over wired or wireless connections), and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for use in a wireless transmit/receive unit (WTRU), comprising:
establishing at least one content sharing session between the WTRU and another WTRU using a local gateway (LGW) connection absent non-local entity connections; and
transmitting content between the WTRU and the other WTRU using the LGW connection during the at least one content sharing session.

2. The method of claim 1, wherein the WTRU is connected to a LGW and the another WTRU is connected to another LGW, and wherein the LGW connection includes a tunnel between the LGW and the another LGW.

3. The method of claim 1, wherein the WTRU and the other WTRU are connected to a LGW and are in a same local network (LN).

4. The method of claim 3, further comprising:
receiving information upon at least one of entry or exit of the another WTRU and other WTRUs to the LN.

5. The method of claim 1, wherein a content sharing indicator is added to a subscription profile, wherein the content sharing indicator includes at least one of content sharing permission, type of content, definition of local network, allowed to share list, and not allowed to share list.

6. The method of claim 1, further comprising:
transmitting a NAS message with a modification code to modify the at least one content sharing session based on an event, wherein the modification code is one of suspension, modification, resumption or termination.

7. The method of claim 1, further comprising:
transmitting a non-access stratum (NAS) message with a content sharing session request;
receiving a NAS response with content sharing session set-up information on a condition that the content sharing session request is accepted; and
receiving a NAS response with a reject code on a condition that the content sharing session request is rejected.

8. The method of claim 1, further comprising:
modifying the at least one content sharing session to at least add at least another WTRU to the at least one content sharing session or delete at least one WTRU that is participating in the at least one content sharing session.

9. The method of claim 1, wherein the at least one content sharing session is multiple content sharing sessions.

10. The method of claim 1, wherein the content is bi-cast to the WTRU and the another WTRU during the at least one content sharing session.

11. The method of claim 1, further comprising:
generating a friend list; and
updating the friend list based on acceptance or rejection of a content sharing request.

12. A method for use in a network entity, comprising:
receiving a non-access stratum (NAS) message with a content sharing session request from a wireless transmit/receive unit (WTRU) wanting to share content with at least one WTRU;
verifying that the WTRU is allowed to participate in a content sharing session;
sending a NAS response with content sharing session set-up information on a condition that the content sharing session request is accepted, wherein the content sharing session between the WTRU and the at least one WTRU is established using a local gateway (LGW) connection absent non-local entity connections; and
sending a NAS response with a reject code on a condition that the content sharing session request is rejected.

13. The method of claim 12, further comprising:
verifying that the at least one WTRU is allowed to participate in the content sharing session.

14. The method of claim 12, wherein the WTRU in connected to a LGW and the at least one WTRU is connected to another LGW, and wherein the LGW connection includes a tunnel between the LGW and the another LGW.

15. The method of claim 12, wherein the WTRU and the other WTRU are connected to a LGW and are in a same local network (LN).

16. The method of claim 12, further comprising:
checking availability of resources for the content sharing session.

17. The method of claim 12, further comprising:
sending a message to other network entities to allocate resources for the content sharing session.

18. The method of claim 17, wherein the message results in bearer connections between the WTRU and the at least one WTRU being made at most at the LGW.

19. The method of claim 12, further comprising:
sending a message to other network entities to establish a tunnel between different LGWs on a condition that the WTRU in connected to a LGW and the at least one WTRU is connected to another LGW.

20. The method of claim 12, further comprising:
sending a notification to the at least one WTRU that a modification request to the content sharing session has been sent by the WTRU.

21. A wireless transmit/receive unit (WTRU) comprising:
a transmitter configured to transmit a non-access stratum (NAS) message with a content sharing session request to a network entity;
a receiver configured to receive a NAS response with content sharing session set-up information on a condition that the content sharing session request is accepted, wherein a processor, the transmitter and the receiver are configured to establish a content sharing session between the WTRU and another WTRU using a local gateway (LGW) connection absent non-local entity connections;
a receiver configured to receive a NAS response with a reject code on a condition that the content sharing session request is rejected; and
a transmitter configured to transmit content between the WTRU and the other WTRU using the LGW connection during the content sharing session.

22. The WTRU of claim 21, wherein the WTRU and the other WTRU are connected to a LGW and are in a same local network (LN).
